(19) United States
(12) Patent Application Publication
(10) Pub. No.: US 2024/0199882 A1
(43) Pub. Date: Jun. 20, 2024

(54) THIENYL-DIBENZOAZEPINES AND THEIR DERIVATIVES AS DONORS FOR XANTHENE-BASED SHORT-WAVE INFRARED (SWIR) DYES

(71) Applicants: Colleen N. Scott, Starkville, MS (US); Chathuranga S. L. Rathnamalala, Frederick, MD (US)

(72) Inventors: Colleen N. Scott, Starkville, MS (US); Chathuranga S. L. Rathnamalala, Frederick, MD (US)

(73) Assignee: Mississippi State University, Starkville, MS (US)

(21) Appl. No.: 18/524,289

(22) Filed: Nov. 30, 2023

Related U.S. Application Data
(60) Provisional application No. 63/385,577, filed on Nov. 30, 2022.

(51) Int. Cl. C09B 49/12; G01N 1/30

(52) U.S. Cl. CPC C09B 49/126; G01N 1/30; G01N 2001/302

(57) ABSTRACT

A near infrared dye comprising a counterion and a structure of Formula I

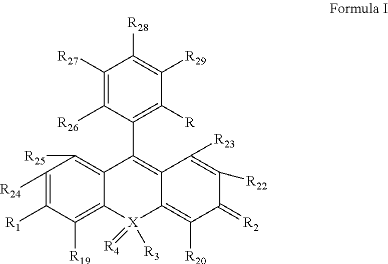

wherein the at least one of R₁ and R₂ are selected from dibenzazepinyl, thienyldibenzazepine, bithienyldibenzazepine, thienodibenzazepine, dihydrodibenzazepinyl, thienyldihydrodibenzazepine, bithienyldihydrodibenzazepine, and thienodihydrodibenzazepine, and X, R, R₃-R₄, R₁₉, R₂₀ and R₂₂-R₂₉ are as disclosed herein. Materials and compositions comprising the SWIR dye can absorb light at a wavelength of 800 nm to 1400 nm and release the energy in the form of light (fluorescence) or heat (non-radiative). The dyes can also convert the absorbed light to heat and ultrasound waves via the photoacoustic effect. The photoacoustic effect can be used in photoacoustic tomography to image biological materials or processes. Methods for synthesizing the SWIR dyes and materials comprising the same are also disclosed.

### CROSS REFERENCE TO RELATED APPLICATIONS

This application claims priority to U.S. provisional application No. 63/385,577, filed on Nov. 30, 2022, the disclosure of which is hereby incorporated by reference in its entirety as if fully set forth herein.

### STATEMENT OF GOVERNMENT INTEREST

This invention was made with government support under grant number OIA-1757220, awarded by the National Science Foundation. The government has certain rights in this invention.

### FIELD OF INVENTION

This invention relates generally to the field of dye materials and, more particularly, to novel shortwave infrared (SWIR) dye materials and compositions that absorb light at wavelengths of 900 nm to 1400 nm, which is ideal for deep tissue imaging owing to minimized light scattering and interference from endogenous pigments when using light in this wavelength range. An approach to access such molecules is to tune the photophysical properties of known near-infrared dyes. A series of easily accessible (three steps) SWIR xanthene dyes has been developed based on a dibenzazepine donor conjugated to thiophene (SCR-1), thienothiophene (SCR-2), or bithiophene (SCR-3). Since SCR-1 undergoes a bathochromic shift when aggregated for in vivo studies, we developed a ratiometric nanoparticle for nitric acid (NO) (rNP-NO), which was employed to visualize pathological levels of nitric oxide in a drug-induced liver injury model via deep tissue SWIR photoacoustic (PA) imaging. This dye series can be utilized as a component in nanosensor designs for imaging studies.

### BACKGROUND

The “biological window” is traditionally considered to span light wavelengths of 650 nm to 900 nm in the near infrared (NIR), a spectral region where interference due to auto-fluorescence is minimal compared to ultraviolet (UV) and visible light. Moreover, less optical absorbers are present that may intercept and scatter light wavelengths of 650 nm to 900 nm, allowing for deeper tissue imaging. These unique properties of NIR light have enabled a variety of applications including photodynamic therapy, image-guided surgery, and photothermal ablation. In vivo molecular imaging via fluorescence and photoacoustic (PA) modes are additional applications that have attracted significant interest owing to their ability to detect biomarkers via activity-based sensing. However, a paradigm shift is currently underway whereby the preferred incident light window employs even longer wavelengths. This so-called shortwave infrared (SWIR) window includes light from 900 nm to 1400 nm, which overlaps less with interfering endogenous pigments like hemoglobin found in blood or melanin in skin. In the context of PA imaging, the use of SWIR imaging agents enables depths (˜10 cm) several times greater than comparable NIR systems.

PA imaging is a modality that relies on the use of light to stimulate the production of acoustic waves (known as the “PA effect”). After a chromophore is excited by a pulsed laser, a portion of the absorbed energy is released as heat, which causes rapid thermoelastic expansion within the sample being imaged. This increase in temperature leads to pressure fluctuations that generate a detectable ultrasound signal, which can be reconstructed to create high-resolution 3D images of the region of interest. The ability of SWIR light to penetrate far into the body results in a more robust PA response in deep tissue. This improvement is necessary for biomedical applications such as the assessment of liver injury from drug overdose. However, most small-molecule dyes operate in the far red to NIR window with only a handful of known SWIR dyes, presumably because they are difficult to prepare, exhibit low chemical stability, and are difficult to formulate (poor solubility or hypsochromic shift) for in vivo studies.

Of the existing SWIR-absorbing dyes, most are based on the polymethine structure (e.g., commercially available IR-1061); however, examples from the aza-BODIPY, benzo[1,2-c:4,5-c]bis([1,2,5]-thiadiazole) (BBTD) core, and xanthene families are also known.

There is a need to improve the case of formation, case of modification and the physical properties of tSWIR-absorbing dyes.

### SUMMARY AND TERMS

The present xanthene based dyes fulfill this need. The wavelength of maximum absorbance of xanthene dyes is moved into the SWIR window using thiophene-dibenzazepine type donor ligands. These xanthene dyes are easy to make, can be readily modified, and exhibit remarkable photophysical properties, i.e., the xanthene dyes can be used for PA imaging, and have high molar absorptivity, low quantum yields, and SWIR absorbance.

A series of three xanthene-based SWIR dyes have been synthesized using a donor-acceptor-donor (D-A-D) design. One example (SCR-1) has been used to prepare a nitric oxide (NO)-responsive probe. The SCR-1 dye has been co-encapsulated together with a second SWIR dye (non-responsive reference) within a biocompatible polymer matrix to generate a robust nanosensor, which can detect NO in deep tissue using a drug-induced liver injury model via ratiometric SWIR PA imaging.

In an aspect, the disclosure relates to a shortwave infrared (SWIR) dye comprising a counterion and a structure of Formula I

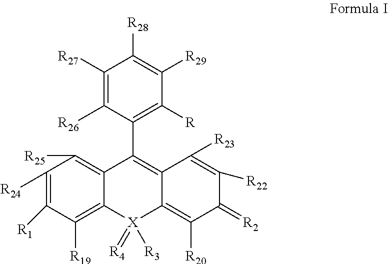

wherein X is selected from O, Si and P;
R is selected from hydrogen, —C(O)OH, a substituted or unsubstituted linear or branched C₁-C₁₈ alkyl group, a substituted or unsubstituted linear or branched C₂-C₁₈ alkenyl group, a substituted or unsubstituted C₃-C₁₀ cycloalkyl group, a substituted or unsubstituted linear or branched C₁-C₁₈ alkoxy group, an ester group represented by the formula: —C(O)OA¹, wherein A¹ is selected from a substituted or unsubstituted linear or branched C₁-C₁₈ alkyl group, a substituted or unsubstituted linear or branched C₂-C₁₈ alkenyl group and a substituted or unsubstituted C₃-C₁₀ cycloalkyl group;
an amide group represented by the formula: —C(O)N(A²)₂, wherein A² is selected from a substituted or unsubstituted linear or branched C₁-C₁₈ alkyl group, a substituted or unsubstituted linear or branched C₂-C₁₈ alkenyl group, a substituted or unsubstituted C₃-C₁₀ cycloalkyl group, and a substituted or unsubstituted C₆-C₁₀ aryl group; and
an ether group represented by the formula —CH₂OA³ wherein A³ is selected from a substituted or unsubstituted linear or branched C₁-C₁₈ alkyl group, a substituted or unsubstituted linear or branched C₂-C₁₈ alkenyl group, and a substituted or unsubstituted C₃-C₁₀ cycloalkyl group;
when X is O, then R₃ and R₄ are absent, and
when X is Si, then R₃ and R₄ are each singly bonded to the Si atom, and are independently selected from, hydrogen, a substituted or unsubstituted C₁-C₁₈ linear or branched alkyl group and a substituted or unsubstituted C₃-C₁₀ cycloalkyl group,
when X is P, then R₃ is singly bonded to the P atom and is selected from hydrogen, a substituted or unsubstituted C₁-C₁₈ linear or branched alkyl group and a substituted or unsubstituted C₃-C₁₀ cycloalkyl group, and R₄ is connected to the P atom by a single bond and is selected from a substituted or unsubstituted C₁-C₁₈ linear or branched alkyl group, and a substituted or unsubstituted C₃-C₁₀ cycloalkyl group or R₄ is connected to the P atom by a double bond and is oxygen;
wherein R₁₉, R₂₀, R₂₂, R₂₃, R₂₄, R₂₅, R₂₆, R₂₇, R₂₈, and R₂₉ are each independently selected from hydrogen, sulfonate, halogen, hydroxy, amino, nitro, cyano, carboxy, an alkyl group having 1 to 20 carbon atoms, an alkenyl group having 2 to 20 carbon atoms, an alkynyl group having 2 to 20 carbon atoms, an aryl group having 6 to 10 carbon atoms, a heterocyclic group having 3 to 16 carbon atoms, an alkylether having 2 to 20 carbon atoms and 1 to 5 oxygen atoms, and an alkoxy group having 1 to 20 carbon atoms, or wherein one or more pair(s) of R₂₂ and R₂₃, R₂₄ and R₂₅, R₂₅ and R₂₆, R₂₆ and R₂₇, R₂₇ and R₂₈, R₂₈ and R₂₉, together with the carbons to which they are attached can form a saturated or unsaturated six membered ring; and
R₁ and R₂ are selected from one of the following Groups A, B and C:

### Group A

R₁ is hydrogen and R₂ is a donor which is substituted or unsubstituted and is selected from a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, and a thienodihydrodibenzazepine;

### Group B (Symmetrical Dyes)

Both R₁ and R₂ are the same donors, are substituted or unsubstituted, and are selected from a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, and a thienodihydrodibenzazepine; and

### Group C (Unsymmetrical Dyes)

R₁ and R₂ are different donors and R₁ is a donor, which is substituted or unsubstituted and is selected from a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, and a thienodihydrodibenzazepine and R₂ is a donor which is substituted or unsubstituted and is selected from a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, a thienodihydrodibenzazepine, 1-(thiophen-2-yl)piperidine, 1-(thieno[3,2-b]thiophen-2-yl)piperidine, 1-([2,2′-bithiophen]-5-yl)piperidine, C₂-C₁₂ dialkyl amino, indolizine-3-yl, diphenylamino, and julolidinyl. In Group C, the dyes are unsymmetrical. For instance, the donor at R₁ could be thienyldibenzazepine and at R₂ could be bithienyldibenzazepine; or both R₁ and R₂ can be thienyldibenzazepine but one of R₁ and R₂ is substituted and the other is not.

In the foregoing embodiment, X can be O, and R₃ and R₄ can be absent;
R can be —C(O)OH, or
R can be selected from an ester group, an amide group, and an ether group and A¹, A², and A³ can be independently selected from a linear or branched C₁-C₁₈ alkyl group, a linear or branched C₂-C₁₈ alkenyl group, a C₃-C₁₀ cycloalkyl group, and a substituted or unsubstituted C₆-C₁₀ aryl group that can be substituted with 1 to 3 substituents independently selected from halogen, sulfonate, hydroxy, amino, nitro, cyano, carboxy, an alkyl group having 1 to 20 carbon atoms, an alkenyl group having 2 to 20 carbon atoms, an alkynyl group having 2 to 20 carbon atoms, an aryl group having 6 to 10 carbon atoms, a heterocyclic group having 3 to 16 carbon atoms, and an alkoxy group having 1 to 20 carbon atoms.

In each of the foregoing embodiments, X can be O, and R₃ and R₄ can be absent;
R can be selected from —C(O)OH or an ester group represented by the formula: —C(O)OA¹, wherein A¹ is selected from a linear or branched C₁-C₆ alkyl group; and
R₁ and R₂ are selected from one of the following Groups A and B:

### Group A

R₁ is hydrogen and R₂ is a donor which is substituted with 0 to 3 substituents and is selected from a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, and a thienodihydrodibenzazepine; or

### Group B

Both R₁ and R₂ are the same donors and are substituted with 0 to 3 substituents, and can be selected from dibenzazepinyl, thienyldibenzazepine, bithienyldibenzazepine, thienodibenzazepine, dihydrodibenzazepinyl, thienyldihydrodibenzazepine, bithienyldihydrodibenzazepine, or thienodihydrodibenzazepine;
wherein the substituents are independently selected from a halogen, sulfonate, hydroxy, amino, nitro, cyano, carboxy, an alkyl group having 1 to 20 carbon atoms, an alkenyl group having 2 to 20 carbon atoms, an alkynyl group having 2 to 20 carbon atoms, an alkylether having 2-20 carbon atoms and 1 to 5 oxygen atoms, an aryl group having 6 to 10 carbon atoms, a heterocyclic group having 3 to 16 carbons, and an alkoxy group having 1 to 20 carbon atoms.

In each of the foregoing embodiments, X can be O, and R₃ and R₄ can be absent;
R is selected from —C(O)OH and an ester group represented by the formula —C(O)OA¹ wherein A¹ is a linear or branched C₁-C₆ alkyl group; and
R₁ and R₂ are both selected from Group C:

### Group C

R₁ and R₂ are different donors and R₁ is a donor which is substituted with 0 to 3 substituents and is selected from a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, and a thienodihydrodibenzazepine and R₂ is a donor which is substituted with 0 to 3 substituents, and is selected from a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, a thienodihydrodibenzazepine, 1-(thiophen-2-yl)piperidine, 1-(thieno[3,2-b]thiophen-2-yl)piperidine, 1-([2,2′-bithiophen]-5-yl)piperidine, C₂-C₁₂ dialkyl amino, indolizine-3-yl, diphenylamino, and julolidinyl;
wherein the substituents are independently selected from halogen, sulfonate, hydroxy, amino, nitro, cyano, carboxy, an alkyl group having 1 to 20 carbon atoms, an alkenyl group having 2 to 20 carbon atoms, an alkynyl group having 2 to 20 carbon atoms, an alkylether group having 2 to 20 carbon atoms and 1 to 5 oxygen atoms, an aryl group having 6 to 10 carbon atoms, a heterocyclic group having 3 to 16 carbon atoms, and an alkoxy group having 1 to 20 carbon atoms.

In each of the foregoing embodiments, X can be O, and R₃ and R₄ can be absent;
R can be —C(O)OH or an ester group represented by the formula —C(O)OA¹ wherein A¹ is selected from a linear or branched C₁-C₆ alkyl group; and
R₁ and R₂ can be both selected from Group C′:

### Group C′

R₁ and R₂ are different donors and R₁ is a donor which is substituted with 0 to 3 substituents and selected from a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, and a thienodihydrodibenzazepine and R₂ is a donor which is substituted with 0 to 3 substituents and is selected from a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, a thienodihydrodibenzazepine, 1-(thiophen-2-yl)piperidine, 1-(thieno[3,2-b]thiophen-2-yl)piperidine, 1-([2,2′-bithiophen]-5-yl)piperidine, diethyl amino, and julolidinyl;
wherein the substituents are independently selected from halogen, sulfonate, hydroxy, amino, nitro, cyano, carboxy, an alkyl group having 1 to 20 carbon atoms, an alkenyl group having 2 to 20 carbon atoms, an alkynyl group having 2 to 20 carbon atoms, an alkylether group having 2 to 20 carbon atoms and 1 to 5 oxygen atoms, an aryl group having 6 to 10 carbon atoms, a heterocyclic group having 3 to 16 carbon atoms, and an alkoxy group having 1 to 20 carbon atoms.

In each of the foregoing embodiments, the counterion is selected from nitrite, sulfate, phosphate, bicarbonate, trifluoroacetate, pentafluoropropanoate, chloride, bromide, iodide, perchlorate, nitrate, benzenesulfonate, p-toluenesulfonate, methylsulfate, ethylsulfate, propylsulfate, tetrafluoroborate, tetraphenylborate, hexafluorophosphate, benzenesulfinate, acetate, trifluoroacetate, propionacetate, benzoate, oxalate, succinate, malonate, oleate, stearate, citrate, monohydrogen diphosphate, dihydrogen monophosphate, pentachlorostannate, chlorosulfonate, fluorosulfonate, trifluoromethansulfonate, hexafluoroarsenate, hexafluoroantimonate, molybdenite, tungstate, titanate, zirconate ions, and any combination thereof.

In each of the foregoing embodiments, the counterion can be selected from trifluoroacetate, pentafluoropropanoate, chloride, bromide, iodide, fluorosulfonate, and trifluoromethansulfonate.

In each of the foregoing embodiments, R₁₉, R₂₀, R₂₂, R₂₃, R₂₄, R₂₅, R₂₆, R₂₇, R₂₈, and R₂₉ can be each independently selected from hydrogen, sulfonate, halogen, hydroxy, amino, nitro, cyano, carboxy, an alkyl group having 1 to 6 carbon atoms, an alkenyl group having 2 to 6 carbon atoms, an alkylether group having 2 to 20 carbon atoms and 1 to 5 oxygen atoms, an aryl group having 6 to 10 carbon atoms, and a heterocyclic group having 6 to 10 carbon atoms, and wherein 0 or 1 pair of R₂₂ and R₂₃, R₂₄ and R₂₅, R₂₅ and R₂₆, R₂₆ and R₂₇, R₂₇ and R₂₈, R₂₈ and R₂₉, together with the carbons to which they are attached can form a saturated or unsaturated six membered ring.

In each of the foregoing embodiments, R₁₉, R₂₀, R₂₂, R₂₃, R₂₄, R₂₅, R₂₆, R₂₇, R₂₈, and R₂₉ can be each independently selected from hydrogen, sulfonate, halogen, hydroxy, an alkyl group having 1 to 6 carbon atoms, and a phenyl group.

In each of the foregoing embodiments, R₁₉, R₂₀, R₂₂, R₂₃, R₂₄, R₂₅, R₂₆, R₂₇, R₂₈, and R₂₉ can be hydrogen.

In each of the foregoing embodiments, the SWIR dye can have one of the following structures:

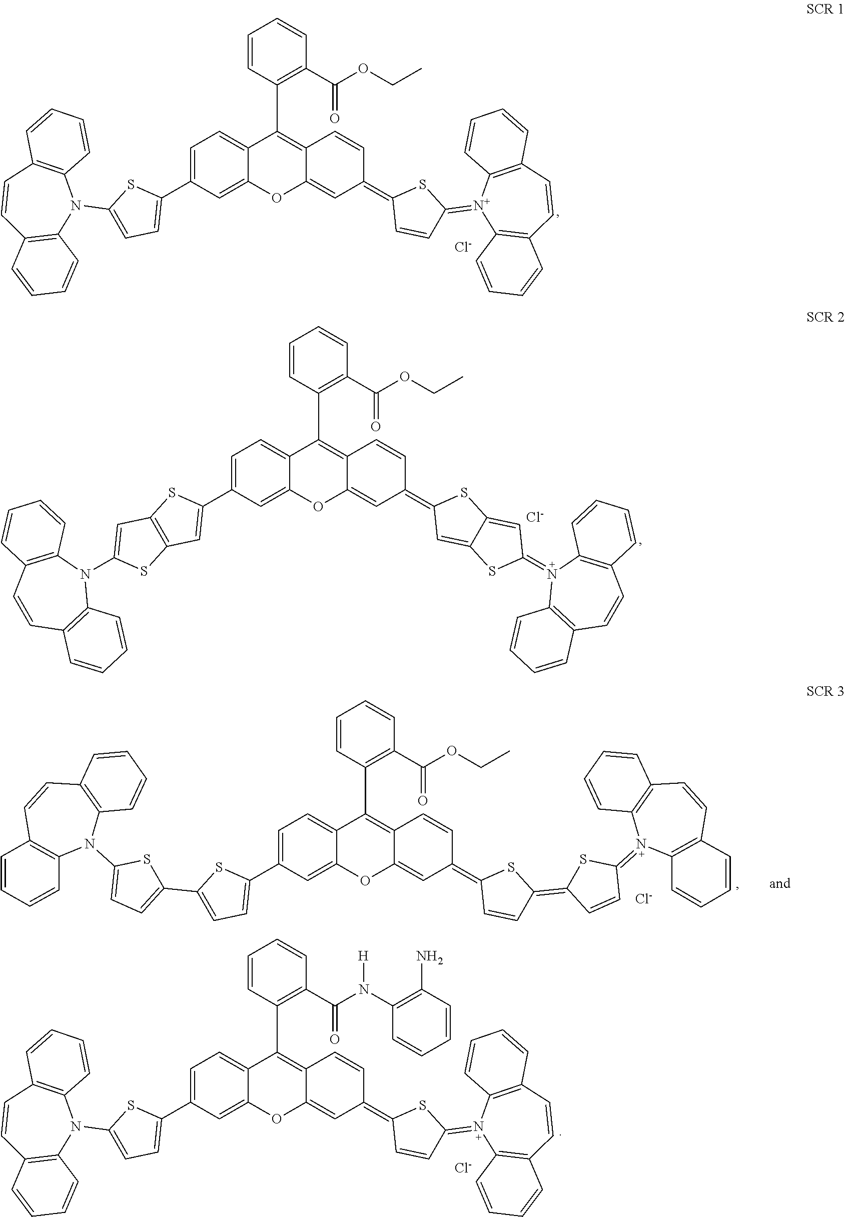

In each of the foregoing embodiments, the SWIR dye can absorb light having a wavelength of 800 nm to 1400 nm.

In another aspect, the disclosure relates to a composite comprising the SWIR dye of any one of foregoing embodiments in a polymer matrix. Preferably, the polymer matrix is solid at room temperature (20° C.).

In another aspect, the disclosure relates to a composite comprising the SWIR dye of any one of the foregoing embodiments encapsulated in a phospholipid-polymer conjugate. In this embodiment, the phospholipid-polymer conjugate may be 1,2-distearoyl-sn-glycero-3-phosphoethanolamine-poly(ethylene glycol) (DSPE-PEG).

Yet another aspect of the disclosure is a method for making a SWIR dye, the method comprising:
(a) performing a C—H arylation reaction by combining a Donor and an Acceptor of Formula II with a catalyst in a solvent to form a reaction mixture,

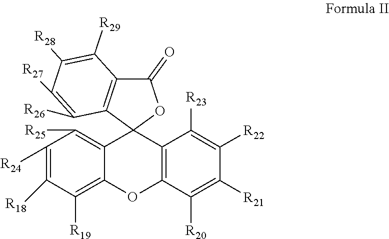

wherein R₁₈ and R₂₁ are independently selected from Cl, Br, I and OSO₂R₅₂, wherein R₅₂ is a hydrogen or C₁-C₄ alkyl;
R₁₉, R₂₀, R₂₂, R₂₃, R₂₄, R₂₅, R₂₆, R₂₇, R₂₈, and R₂₉ are independently selected from hydrogen and an alkyl group having 1 to 20 carbons, or one or more pair(s) of R₂₂ and R₂₃, R₂₄ and R₂₅, R₂₅ and R₂₆, R₂₆ and R₂₇, R₂₇ and R₂₈, R₂₈ and R₂₉, together with the carbons to which they are attached can form a saturated or unsaturated six membered ring; and
the Donor(s) can be substituted or unsubstituted and comprise at least one component from Group (X) and one component from Group (Y):
   Group (X) dibenzazepinyl, thienyldibenzazepine, bithienyldibenzazepine, thienodibenzazepine, dihydrodibenzazepinyl, thienyldihydrodibenzazepine, bithienyldihydrodibenzazepine, and thienodihydrodibenzazepine; and
   Group (Y) dibenzazepinyl, thienyldibenzazepine, bithienyldibenzazepine, thienodibenzazepine, dihydrodibenzazepinyl, thienyldihydrodibenzazepine, bithienyldihydrodibenzazepine, thienodihydrodibenzazepine, 1-(thiophen-2-yl)piperidine, 1-(thieno[3,2-b]thiophen-2-yl)piperidine, 1-([2,2′-bithiophen]-5-yl)piperidine, C₂-C₁₂ dialkyl amine, indolizine, diphenylamine, and julolidine,
      The Donor(s) are used to replace the groups at R₁₈ and R₂₁ with the Donor(s);
(b) a ring opening reaction by transesterification with an alcohol to provide the SWIR dyes of Formula I

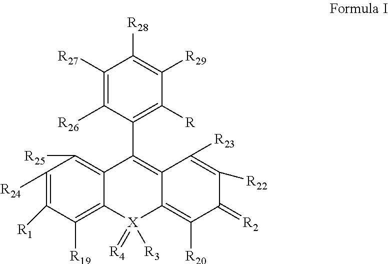

wherein X is O, and R₃ and R₄ are absent;
R is selected from —C(O)OH or an ester group represented by the formula C(O)OA¹, wherein A¹ is a linear or branched C₁-C₁₈ alkyl group;
R₁₉, R₂₀, R₂₂, R₂₃, R₂₄, R₂₅, R₂₆, R₂₇, R₂₈, and R₂₉ are as described above; and R₁ and R₂ are independently selected from one of the following Groups B and C:

### Group B (Symmetrical Dyes)

Both R₁ and R₂ are the same donors, are substituted or unsubstituted, and are selected from a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, and a thienodihydrodibenzazepine; and

### Group C (Unsymmetrical Dyes)

R₁ and R₂ are different donors and R₁ is a donor which is substituted or unsubstituted and is selected from a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, and a thienodihydrodibenzazepine and R₂ is a donor which is substituted or unsubstituted and is selected from a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, a thienodihydrodibenzazepine, 1-(thiophen-2-yl)piperidine, 1-(thieno[3,2-b]thiophen-2-yl)piperidine, 1-([2,2′-bithiophen]-5-yl)piperidine, C₂-C₁₂ dialkyl amino, indolizine-3-yl, diphenylamino, and julolidinyl. The Group C dyes are unsymmetrical. For instance, the donor at R₁ could be a thienyldibenzazepine and at R₂ the donor could be a thienodibenzazepine; or both R₁ and R₂ can be thienyldibenzazepine but one is substituted and the other is not.

In the foregoing embodiment, the catalyst in step (a) can be a palladium compound.

In each of the foregoing embodiments, the compound of Formula II can be as follows:

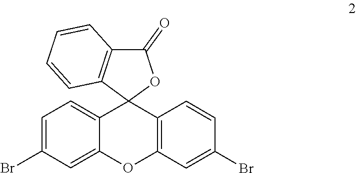 [SMILES: O=C1OC2(c3ccc(Br)cc3Oc3cc(Br)ccc32)c2ccccc21]

In each of the foregoing embodiments, the compound formed in step (a) can have the following structure:

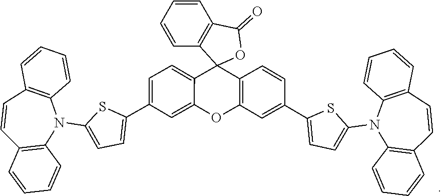 [SMILES: O=C1OC2(c3ccc(-c4ccc(N5c6ccccc6C=Cc6ccccc65)s4)cc3Oc3cc(-c4ccc(N5c6ccccc6C=Cc6ccccc65)s4)ccc32)c2ccccc21]

In yet another aspect, the disclosure relates to a composition comprising the SWIR dyes of any one of the foregoing embodiments and a pharmaceutically acceptable carrier or a solid polymer matrix.

In yet another aspect, the disclosure relates to a method for imaging a biological sample, the method comprising:
(a) contacting the biological sample with an effective amount of a composition as disclosed in each of the foregoing embodiments;
(b) exposing the biological sample and the composition to SWIR radiation; and
(C) observing photoacoustic resonance or fluorescence in the biological sample.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of. The transitional phrase “consisting essentially of” limits the scope of a claim to the specified materials or steps and those that do not materially affect the basic and novel characteristic(s) of the claimed invention.

As used in the specification and the appended claims, the singular forms “a,” “an” and “the” include plural referents unless the context clearly dictates otherwise. Thus, for example, reference to “a solvent,” “a linear alkyl group,” or “an alcohol,” include, but are not limited to, mixtures or combinations of two or more such solvents, linear alkyl groups, or alcohols, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ to less than ‘y’.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated, ± a 10% variation, unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a SWIR dye for imaging of a biological sample refers to an amount that is sufficient to achieve the desired image quality. The specific level in terms of wt % or mol % in a composition required as an effective amount will depend upon a variety of factors including the absorption maxima of the dye, whether the biological sample is an isolated sample or is part of an organism in vivo, the identity of any pharmaceutically acceptable carrier, and the capabilities of the device used to measure the photoacoustic signal produced by the dye via non-radiative decay.

As used herein, the term “donor” refers to an electron donor and the term “acceptor” refers to an electron acceptor in a donor-acceptor or donor-acceptor-donor molecule or dye. The terms “donor” and “acceptor” may be used to refer to the radicals in a donor-acceptor molecule or dye or may be used to refer to separate chemical compounds that will form a donor-acceptor molecule once reacted together.

As used herein, the terms “optional” or “optionally” mean that the subsequently described event or circumstance can or cannot occur, and that the description includes instances where said event or circumstance occurs and instances where it does not.

Unless otherwise specified, pressures referred to herein are based on atmospheric pressure (i.e. one atmosphere).

“SWIR” as used herein refers to the region of the electromagnetic spectrum having wavelengths of from about 800 nm to about 1400 nm, or from about 900 nm to about 1400 nm. In one aspect, the compounds disclosed herein emit fluorescence and/or absorb radiation in the SWIR region.

As used herein, “fluorescence quantum yield” (ϕ) refers to the ratio of photons absorbed to photons emitted through fluorescence.

“Molar absorptivity,” “molar absorption coefficient,” and “extinction coefficient” refer to how strongly a chemical compound absorbs light at a given wavelength. Molar absorptivity is an intrinsic property of the compound; however, this coefficient varies with wavelength and solvent. Molar absorptivity is typically expressed in terms of absorption at a particular wavelength, such as the maximum position in the absorption band. Units are typically given as L/mol·cm or M⁻¹·cm⁻¹. In one aspect, the disclosed SWIR dyes have a high & in the SWIR spectral region.

In one aspect, the SWIR dye has an absorption maximum in dimethyl sulfoxide (DMSO) at from about 800 nm to about 1400 nm, or about 810 nm to about 1200 nm, or from about 830 nm to about 1100 nm.

In another aspect, the SWIR dye has a molar absorption coefficient of about 70,000 M⁻¹·cm⁻¹ or greater, or of about 75,500 M⁻¹·cm⁻¹, 76,000 M⁻¹·cm⁻¹, 76,500 M⁻¹·cm⁻¹, 77,000 M⁻¹·cm⁻¹, 77,500 M⁻¹·cm⁻¹, 78,000 M⁻¹·cm⁻¹, 78,500 M⁻¹·cm⁻¹, or about 78,900 M⁻¹·cm⁻¹ or greater; or up to about 140,500 M⁻¹·cm⁻¹, 138,000 M⁻¹·cm⁻¹, 130,500 M⁻¹·cm⁻¹, or about 122,900 M⁻¹·cm⁻¹ or a combination of any of the foregoing values, or a range encompassing any of the foregoing values. In still another aspect, the SWIR dye has a fluorescence quantum yield of less than 5%, or less than 4%.

### Chemical Groups and Substituents

As used herein, the term “substituted” is contemplated to include all permissible substituents of organic compounds while not materially affecting the basic and novel characteristic(s) of the claimed invention. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc.

The term “alkyl” as used herein is a linear, branched, or cyclic saturated hydrocarbon group of 1 to 20 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, and the like. The alkyl group can be cyclic (also referred to as “carbocyclic”) or acyclic. The alkyl group can be branched or unbranched. The alkyl group can also be substituted or unsubstituted. For example, the alkyl group can be substituted with 1 to 3 substituents independently selected from a halogen, sulfonate, hydroxy, amino, nitro, cyano, carboxy, a heterocyclic group having 3 to 16 carbon atoms, an alkylether having 2 to 20 carbon atoms and 1 to 5 oxygen atoms, and an alkoxy group having 1 to 20 carbon atoms. A “lower alkyl” group is an alkyl group containing from one to six (e.g., from one to four) carbon atoms. The term alkyl group can also be a C₁ alkyl, C₁-C₂ alkyl, C₁-C₃ alkyl, C₁-C₄ alkyl, C₁-C₅ alkyl, C₁-C₆ alkyl, C₁-C₇ alkyl, C₁-C₈ alkyl, C₁-C₉ alkyl, C₁-C₁₀ alkyl, and the like up to and including a C₁-C₁₈ alkyl.

The term “cycloalkyl” as used herein is a non-aromatic carbon-based ring composed of three carbon atoms to ten carbon atoms. Examples of cycloalkyl groups include, but are not limited to, cyclopropyl, cyclobutyl, cyclopentyl, cyclohexyl, norbornyl, and the like.

The terms “alkoxy” and “alkoxyl” as used herein to refer to an alkyl or cycloalkyl group bonded through an ether linkage; that is, an “alkoxy” group can be defined as -OA¹ where A¹ is alkyl, alkenyl or cycloalkyl as defined above.

The term “aromatic” as used herein refers to a ring structure having cyclic clouds of delocalized π electrons above and below the plane of the molecule, where the π clouds contain (4n+2) π electrons. A further discussion of aromaticity is found in Morrison and Boyd, Organic Chemistry, (5th Ed., 1987), Chapter 13, entitled “Aromaticity,” pages 477-497, incorporated herein by reference. The term “aromatic group” is inclusive of both aryl and heteroaryl groups.

The term “aryl” as used herein is a group that contains any carbon-based aromatic group including, but not limited to, benzene, naphthalene, phenyl, biphenyl, anthracene, pyrene, and the like. The aryl group can be substituted or unsubstituted. The aryl group can be substituted with one or more groups including, but not limited to, alkyl, cycloalkyl, alkoxy, alkenyl, cycloalkenyl, alkynyl, cycloalkynyl, aryl, heteroaryl, aldehyde, —NH₂, carboxylic acid, ester, ether, halide, hydroxy, ketone, azide, nitro, silyl, sulfo-oxo, or thiol as described herein.

The term “aldehyde” as used herein is represented by the formula: —C(O)H. Throughout this specification “C(O)” is a shorthand notation for a carbonyl group, i.e., C═O.

The terms “amine” or “amino” as used herein are represented by the formula: —NA¹A², where A¹ and A² can be, independently, hydrogen or alkyl, cycloalkyl, alkenyl, cycloalkenyl, alkynyl, cycloalkynyl, aryl, or heteroaryl group as described herein. A specific example of amino is —NH₂.

The term “carboxylic acid” as used herein is represented by the formula: —C(O)OH.

The term “ester” as used herein is represented by the formulae: —OC(O)A¹ and —C(O)OA¹, where A¹ is selected from alkyl, cycloalkyl, alkenyl, cycloalkenyl, alkynyl, cycloalkynyl, aryl, and heteroaryl.

The term “amide” as used herein is represented by the formulae: —N(A¹)C(O)A² and —C(O)N(A²)₂, where A¹ and A² are independently selected from hydrogen, alkyl, cycloalkyl, alkenyl, cycloalkenyl, alkynyl, cycloalkynyl, aryl, and heteroaryl.

The term “ether” as used herein is represented by the formula: -A¹OA², where A¹ and A² are independently selected from alkyl, cycloalkyl, alkenyl, cycloalkenyl, alkynyl, cycloalkynyl, aryl, and heteroaryl.

The terms “halo,” “halogen” or “halide,” as used herein can be used interchangeably and refer to a group selected from —F, —Cl, —Br, and —I.

The term “heteroalkyl” as used herein refers to an alkyl group containing at least one heteroatom. Suitable heteroatoms include, but are not limited to, O, N, Si, P and S, wherein the nitrogen, phosphorous and sulfur atoms are optionally oxidized, and the nitrogen heteroatom is optionally quaternized. Heteroalkyl groups can be substituted as defined above for alkyl groups.

The terms “heterocycle”, “heterocyclic” or “heterocyclyl,” as used herein can be used interchangeably and refer to single and multi-cyclic aromatic (heteroaromatic) or non-aromatic ring (heteroalkyl) systems in which at least one of the ring members is other than carbon. Heterocycle includes pyridine, pyrimidine, furan, thiophene, pyrrole, isoxazole, isothiazole, pyrazole, oxazole, thiazole, imidazole, oxazole, including, 1,2,3-oxadiazole, 1,2,5-oxadiazole and 1,3,4-oxadiazole, thiadiazole, including, 1,2,3-thiadiazole, 1,2,5-thiadiazole, and 1,3,4-thiadiazole, triazole, including, 1,2,3-triazole, 1,3,4-triazole, tetrazole, including 1,2,3,4-tetrazole and 1,2,4,5-tetrazole, pyridazine, pyrazine, triazine, including 1,2,4-triazine and 1,3,5-triazine, tetrazine, including 1,2,4,5-tetrazine, pyrrolidine, piperidine, piperazine, morpholine, azetidine, tetrahydropyran, tetrahydrofuran, dioxane, and the like. The term heterocyclyl group can also be a C₂ heterocyclyl, C₂-C₃ heterocyclyl, C₂-C₄ heterocyclyl, C₂-C₅ heterocyclyl, C₂-C₆ heterocyclyl, C₂-C₇ heterocyclyl, C₂-C₈ heterocyclyl, C₂-C₉ heterocyclyl, C₂-C₁₀ heterocyclyl, C₂-C₁₁ heterocyclyl, and the like up to and including a C₂-C₁₈ heterocyclyl. For example, a C₂ heterocyclyl comprises a group which has two carbon atoms and at least one heteroatom, including, but not limited to, aziridinyl, diazetidinyl, dihydrodiazetyl, oxiranyl, thiiranyl, and the like. Alternatively, for example, a C₅ heterocyclyl comprises a group which has five carbon atoms and at least one heteroatom, including, but not limited to, piperidinyl, tetrahydropyranyl, tetrahydrothiopyranyl, diazepanyl, pyridinyl, and the like. It is understood that a heterocyclyl group may be bound either through a heteroatom in the ring, where chemically possible, or one of carbons comprising the heterocyclyl ring.

The term “hydroxyl” or “hydroxy” as used herein is represented by the formula —OH.

The term “nitro” as used herein is represented by the formula —NO₂.

The term “nitrile” or “cyano” as used herein is represented by the formula —CN.

As described herein, compounds of the invention may contain “optionally substituted” moieties. In general, the term “substituted,” whether preceded by the term “optionally” or not, means that one or more hydrogens of the designated moiety are replaced with a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned by this invention are preferably those that result in the formation of stable or chemically feasible compounds. It is also contemplated that, in certain aspects, unless expressly indicated to the contrary, individual substituents can be further optionally substituted (i.e., further substituted or unsubstituted).

The term “radical,” refers to a fragment, group, or substructure of a molecule described herein, regardless of how the molecule is prepared. For example, a 2,4-thiazolidinedione radical in a particular compound has the structure:

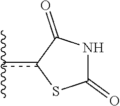

regardless of whether thiazolidinedione is used to prepare the compound. In some embodiments the radical (for example an alkyl) can be further modified (i.e., substituted alkyl) by having bonded thereto one or more “substituent radicals.” The number of atoms in a given radical is not critical to the present invention unless it is indicated to the contrary elsewhere herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows the normalized absorption spectra of a dibenzazepine donor conjugated to thiophene (SCR-1), thienothiophene (SCR-2), or bithiophene (SCR-3) in CH₂Cl₂.

FIG. 2 shows the normalized emission spectra of SCR-1, SCR-2, and SCR-3 in CH₂Cl₂.

FIG. 3A shows the normalized absorbance spectra of a ratiometric nanoparticle for nitric oxide (rNP-NO) before addition of NO (100 μm).

FIG. 3B shows the normalized absorbance spectra of rNP-NO after addition of NO (100 μm).

FIG. 3C shows the normalized ratiometric turn-on (λ_{SCR-NO}/λ_{IR-1061}) of rNP-NO after addition of NO (100 μM) and its vehicle control.

FIG. 3D shows the ratiometric turn-on (λ_{SCR-NO}/λ_{IR-1061}) of rNP-NO after treatment with various biological analytes for 1 hour. Concentrations were at 100 μM, except for cysteine (Cys) (200 μM), glutathione (GSH) (5 mM), and hydroxyl radical (1 μM).

FIG. 3E shows photoacoustic (PA) images of rNP-NO (0.1, 0.2, or 0.3 g/mL) embedded in a tissue-mimicking phantom that was 3 cm thick. The mages were compiled from multiple experiments recorded using the same imaging conditions.

FIG. 3F shows quantified data from the data shown in FIG. 3E. In FIG. 3F, n=3 for all experiments. Error bars=standard error of mean (SEM). Statistical analysis was performed using a two-tailed t-test (α=0.05, ** P<0.05).

FIG. 4 shows a proposed reaction mechanism between NO (via N₂O₃) and SCR-NO in image a). In image a), SCR-NO and the free carboxylate are PA-active; however, after hydrolysis to the corresponding carboxylic acid product, spontaneous spiro-lactonization yields the closed PA-inactive product. Image b) of FIG. 4 shows the chemical structure of the NO-Responsive Probe (SCR-NO), PA-inactive turnover product form of SCR-NO, and the SWIR Reference Dye (IR-1061). Image c) of FIG. 4 shows a cartoon schematic showing the production of two SWIR signals before reaction with NO and one SWIR signal (from the reference IR-1061) after reaction with NO.

FIG. 5A shows normalized absorption spectra of SCR-NO in CH₂Cl₂ and NP-SCR-NO in water.

FIG. 5B shows normalized absorption spectra of IR-1061 in CH₂Cl₂ and NP-IR-1061 in water.

FIG. 5C shows the normalized absorption spectra of SCR-NO in CH₂Cl₂, IR-1061 in CH₂Cl

FIG. 6A shows representative cross-sectional shortwave-infrared meso-patterned imaging (SWIR) photoacoustic (PA) images of the liver from mice treated with saline (control, n=3) and representative cross-sectional shortwave-infrared meso-patterned imaging (SWIR) photoacoustic (PA) images of the liver from mice treated with acetaminophen (APAP) (treatment group, n=4).

FIG. 6B shows a cartoon schematic identifying the liver in cross-sectional view.

FIG. 6C shows quantified ratiometric data from FIGS. 6A and 6B. The scale bar represents 5 mm. The statistical analysis was performed using a two-tailed t-test (α=0.05, * P<0.05).

### DETAILED DESCRIPTION

Small molecule organic dyes may be attractive for clinical applications because of their tendency to metabolize in the cells and their potential for low toxicity. Disclosed herein is a method for making SWIR organic dyes by combining donor and acceptor groups. In one aspect, the choice of a good donor—acceptor pair can significantly lower the optical bandgap of a dye due to the promotion of charge transfer events.

The novel SWIR dyes can be used in biological imaging such as in vivo photoacoustic or fluorescence imaging of tumor angiogenesis monitoring, blood oxygenation mapping, functional brain imaging, skin melanoma detection, methemoglobin measuring, etc. In one aspect, the disclosure provides new materials that absorb light in the SWIR region where biological tissues are most transparent. In a further aspect, the compositions allow for direct, real-time laser imaging of biological samples at a faster, more affordable rate than an MRI, while also potentially allowing real time analysis during surgery.

The xanthene-based dyes of the disclosure have outstanding photophysical properties and stimuli responses. For instance, the new SWIR xanthene-based PA imaging agents SCR-1, SCR-2 and SCR-3 have absorption maxima at 840, 950 and 1040, respectively.

These three dyes were made using the donor-acceptor-donor (D-A-D) design. These dyes were based on two factors: (i) a good overlap of the thiophene donor and xanthene acceptor to lower the bandgap of the dye due to charge transfer events, and (ii) an amino group connected to the thiophene to increase donor strength in the push-pull mechanism of xanthene-based dyes.

### Donors

The xanthene dyes can be in a donor-acceptor (D-A) design or a donor-acceptor-donor (D-A-D) design. For the D-A-D design, the donors can be symmetrical or unsymmetrical. For symmetrical dyes, R₁ and R₂ are identical donors. For unsymmetrical dyes, R₁ and R₂ are not identical.

Although the structures described and drawn herein show the cationic charge on a single atom, the donors can be in resonance with one another such that the cationic charge can move from the donor at R₁ to the donor at R_{2.} R₁ and R₂ can be selected from one of the following Groups A, B and C:

### Group A

R₁ is hydrogen and R₂ is a donor which is selected from a substituted or unsubstituted dibenzazepinyl, thienyldibenzazepine, bithienyldibenzazepine, thienodibenzazepine, dihydrodibenzazepinyl, thienyldihydrodibenzazepine, bithienyldihydrodibenzazepine, and thienodihydrodibenzazepine;

### Group B (Symmetrical Dyes)

Both R₁ and R₂ are the same donors, are substituted or unsubstituted and are selected from dibenzazepinyl, thienyldibenzazepine, bithienyldibenzazepine, thienodibenzazepine, dihydrodibenzazepinyl, thienyldihydrodibenzazepine, bithienyldihydrodibenzazepine, and thienodihydrodibenzazepine; and

### Group C (Unsymmetrical Dyes)

R₂ is a different donor from R₁, and R₁ is a donor which is selected from a substituted or unsubstituted dibenzazepinyl, thienyldibenzazepine, bithienyldibenzazepine, thienodibenzazepine, dihydrodibenzazepinyl, thienyldihydrodibenzazepine, bithienyldihydrodibenzazepine, and thienodihydrodibenzazepine, and R₂ is a donor which is substituted or unsubstituted, and is selected from dibenzazepinyl, thienyldibenzazepine, bithienyldibenzazepine, thienodibenzazepine, dihydrodibenzazepinyl, thienyldihydrodibenzazepine, bithienyldihydrodibenzazepine, thienodihydrodibenzazepine, 1-(thiophen-2-yl)piperidine, 1-(thieno[3,2-b]thiophen-2-yl)piperidine, 1-([2,2′-bithiophen]-5-yl)piperidine, a C₂-C₁₂ dialkyl amine, indolizine derivative, diphenylamine, and julolidine.

In Group B, the dyes are symmetrical, such as XanthCR-880. In Group C, the dyes are unsymmetrical. For instance, the donor at R₁ could be thienyldibenzazepine and at R₂ could be bithienyldibenzazepine; or both R₁ and R₂ can be thienyldibenzazepine but one is substituted and the other is not.

The preferred structures of the donors are shown below.

### 1. Dibenzazepine

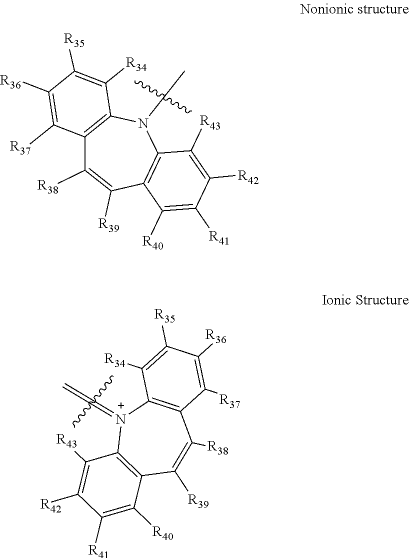

wherein R₃₄, R₃₅, R₃₆, R₃₇, R₃₈, R₃₉, R₄₀, R₄₁, R₄₂, and R₄₃ are independently selected from hydrogen, halogen, hydroxy, amino, nitro, cyano, carboxy, an alkyl group having 1 to 20 carbon atoms, an alkenyl group having 2 to 20 carbon atoms, an alkynyl group having 2 to 20 carbon atoms, an alkoxy group having 1 to 20 carbon atoms, an alkylether group having 2 to 20 carbon atoms and 1 to 5 oxygen atoms, an aryl group having 6 to 10 carbon atoms, and a heterocyclic group having 3 to 16 carbon atoms. Preferably the dibenzazepine has 3 or fewer substituents, more preferably 1 substituent and most preferably no substituents. These dibenzazepine donors are derived from the following ring structure:

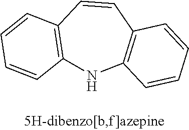

The disclosure also includes dihydrogenated dibenzazepines as optional donors, wherein the above structures containing the R₃₄, R₃₅, R₃₆, R₃₇, R₃₈, R₃₉, R₄₀, R₄₁, R₄₂, and R₄₃ ligands are modified such that the carbons bonded to the R₃₈ and R₃₉ ligands each have an additional hydrogen attached thereto and the double bond between the carbons bonded to the R₃₈ and R₃₉ ligands is a single bond. These dihydrogenated dibenzazepine donors are sometimes referred to herein as dihydrodibenzazepinyl groups and are derived from a 10,11-dihydro-5H-dibenzo[b,f]azepine ring.

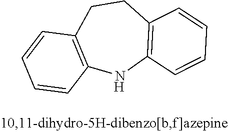

### 2. Thienyldibenzazepine

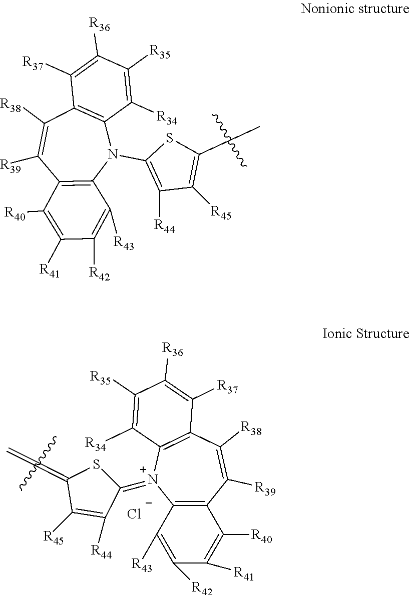

wherein R₃₄, R₃₅, R₃₆, R₃₇, R₃₈, R₃₉, R₄₀, R₄₁, R₄₂, and R₄₃ are as described above. R₄₄ and R₄₅ are each independently selected from hydrogen, halogen, hydroxy, amino, nitro, cyano, carboxy, an alkyl group having 1 to 20 carbon atoms, an alkenyl group having 2 to 20 carbon atoms, an alkynyl group having 2 to 20 carbon atoms, an aryl group having 6 to 10 carbon atoms, a heterocyclic group having 3 to 16 carbon atoms, an alkoxy group having 1 to 20 carbon atoms, and an alkylether group having 2 to 20 carbon atoms and 1 to 5 oxygen atoms. Preferably, the thienyldibenzazepine has 3 or fewer substituents, more preferably 1 substituent and most preferably no substituents. These thienyldibenzazepine donors are derived from the following ring structure:

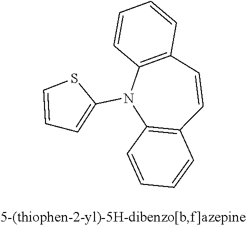 [SMILES: C1=Cc2ccccc2N(c2cccs2)c2ccccc21]

The disclosure also includes dihydrogenated thienyldibenzazepines as optional donors, wherein the above-structures containing the R₃₄-R₄₅ ligands are modified such that the carbons bonded to the R₃₈ and R₃₉ ligands each have an additional hydrogen attached thereto and the double bond between the carbons bonded to the R₃₈ and R₃₉ ligands is, instead, a single bond. These dihydrogenated thienyldibenzazepine donors are sometimes referred to herein as thienyldihydrodibenzazepine groups and are derived from the following ring structure:

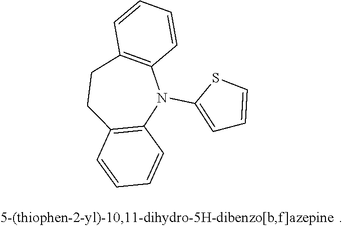 [SMILES: c1csc(N2c3ccccc3CCc3ccccc32)c1]

### 3. Bithienyldibenzazepine

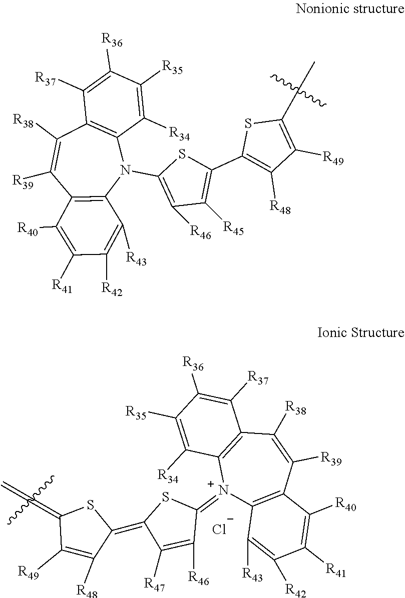

wherein R₃₄, R₃₅, R₃₆, R₃₇, R₃₈, R₃₉, R₄₀, R₄₁, R₄₂, and R₄₃ are as described above. R₄₆, R₄₇, R₄₈ and R₄₉ are each independently selected from hydrogen, halogen, hydroxy, amino, nitro, cyano, carboxy, an alkyl group having 1 to 20 carbon atoms, an alkenyl group having 2 to 20 carbon atoms, an alkynyl group having 2 to 20 carbon atoms, an aryl group having 6 to 10 carbon atoms, a heterocyclic group having 3 to 16 carbon atoms, an alkoxy group having 1 to 20 carbon atoms, and an alkylether group having 2 to 20 carbon atoms and 1 to 5 oxygen atoms. Preferably, the bithienyldibenzazepine has 3 or fewer substituents, more preferably 1 substituent and most preferably no substituents. These bithienyldibenzazepine donors are derived from the following ring structure:

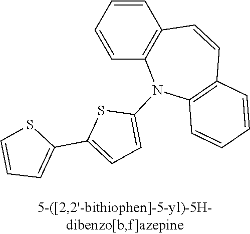 [SMILES: C1=Cc2ccccc2N(c2ccc(-c3cccs3)s2)c2ccccc21]

The disclosure also includes dihydrogenated bithienyldibenzazepines as optional donors, wherein the above-structures containing the R₃₄-R₄₃ and R₄₆-R₄₉ ligands are modified such that the carbons bonded to the R₃₈ and R₃₉ ligands each have an additional hydrogen attached thereto and the double bond between the carbons bonded to R₃₈ and R₃₉ ligands is instead a single bond. These dihydrogenated bithienyldibenzazepine donors are sometimes referred to herein as bithienyldihydrodibenzazepine groups and are derived from the following ring structure:

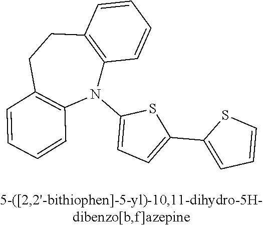 [SMILES: c1csc(-c2ccc(N3c4ccccc4CCc4ccccc43)s2)c1]

### Thienodibenzazepine

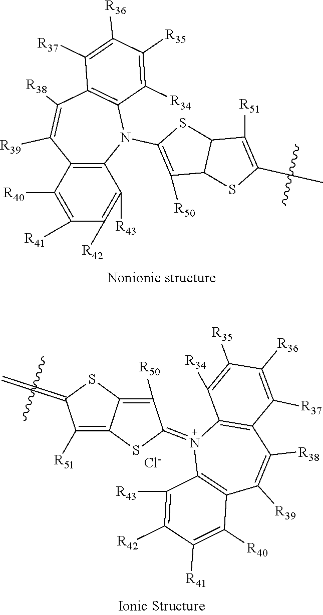

wherein R₃₄, R₃₅, R₃₆, R₃₇, R₃₈, R₃₉, R₄₀, R₄₁, R₄₂, and R₄₃ are as described above. R₅₀ and R₅₁ are each independently selected from hydrogen, halogen, hydroxy, amino, nitro, cyano, carboxy, an alkyl group having 1 to 20 carbon atoms, an alkenyl group having 2 to 20 carbon atoms, an alkynyl group having 2 to 20 carbon atoms, an aryl group having 6 to 10 carbon atoms, a heterocyclic group having 3 to 16 carbons, an alkoxy group having 1 to 20 carbon atoms, and an alkylether group having 2 to 20 carbon atoms and 1 to 5 oxygen atoms. Preferably, the thienodibenzazepine has 3 or fewer substituents, more preferably 1 substituent and most preferably no substituents. These thienodibenzazepine donors are derived from the following ring structure:

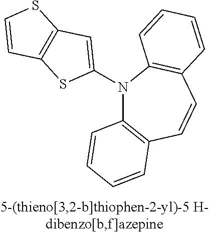 [SMILES: C1=Cc2ccccc2N(c2cc3sccc3s2)c2ccccc21]

The disclosure also includes dihydrogenated thienodibenzazepines as optional donors, wherein the above-structures containing the R₃₄-R₄₃ and R₅₀-R₅₁ ligands are modified such that the carbons bonded to the R₃₈ and R₃₉ ligands each have an additional hydrogen attached thereto and the double bond between the carbons bonded to R₃₈ and R₃₉ ligands is instead a single bond. These dihydrogenated thienodibenzazepine donors are sometimes referred to herein as thienodihydrodibenzazepine groups and are derived from the following ring structure:

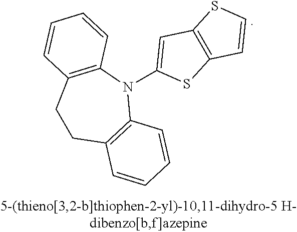 [SMILES: c1ccc2c(c1)CCc1ccccc1N2c1cc2sccc2s1]

### 1-(thiophen-2-yl)piperidine

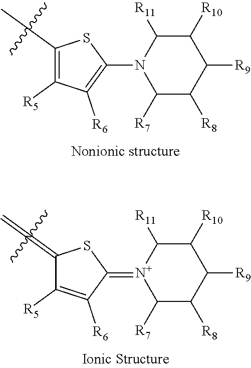

wherein R₅, R₆, R₇, R₈, R₉, R₁₀, and R₁₁ are each independently selected from hydrogen, sulfonate, halogen, hydroxy, amino, nitro, cyano, carboxy, an alkyl group having 1 to 20 carbons, an alkenyl group having 2 to 20 carbon atoms, an alkynyl group having 2 to 20 carbon atoms, an aryl group having 6 to 10 carbon atoms, a heterocyclic group having 3 to 16 carbon atoms, an alkoxy group having 1 to 20 carbon atoms, and an alkylether group having 2-20 carbon atoms and 1 to 5 oxygen atoms. Preferably, the 1-(thiophen-2-yl)piperidine has 3 or fewer substituents, more preferably 1 substituent and most preferably no substituents, in other words, most preferably all of R₅, R₆, R₇, R₈, R₉, R₁₀, and R₁₁ are hydrogen.

The wavy line [symbol] is globally used herein to refer to the location of the bond between the donor and the xanthene core structure.

### 1-(Thieno[3,2-b]thiophen-2-yl)piperidine

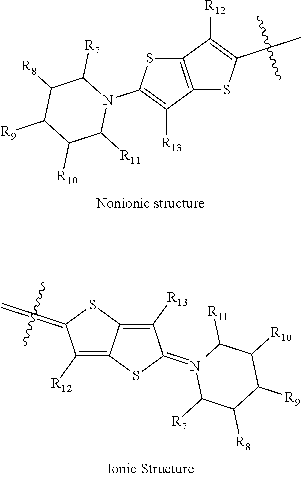

wherein R₇, R₈, R₉, R₁₀, and R₁₁ are as described above. R₁₂ and R₁₃ are each independently selected from hydrogen, sulfonate, halogen, hydroxy, amino, nitro, cyano, carboxy, an alkyl group having 1 to 20 carbon atoms, an alkenyl group having 2 to 20 carbon atoms, an alkynyl group having 2 to 20 carbon atoms, an aryl group having 6 to 10 carbon atoms, a heterocyclic group having 3 to 16 carbon atoms, an alkoxy group having 1 to 20 carbon atoms, and an alkylether group having 2 to 20 carbon atoms and 1 to 5 oxygen atoms. Preferably, the 1-(thieno[3,2-b]thiophen-2-yl)piperidine has 3 or fewer substituents, more preferably 1 substituent and most preferably no substituents.

### 1-([2,2′-Bithiophen]-5-yl)piperidine

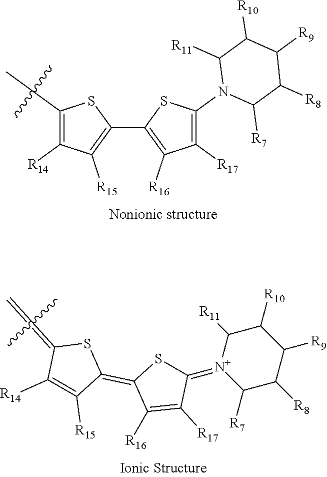

wherein R₇, R₈, R₉, R₁₀, and R₁₁ are as described above. R₁₄, R₁₅, R₁₆, and R₁₇ are each independently selected from hydrogen, sulfonate, halogen, hydroxy, amino, nitro, cyano, carboxy, an alkyl group having 1 to 20 carbon atoms, an alkenyl group having 2 to 20 carbon atoms, an alkynyl group having 2 to 20 carbon atoms, an aryl group having 6 to 10 carbon atoms, a heterocyclic group having 3 to 16 carbon atoms, an alkoxy group having 1 to 20 carbon atoms, and an alkylether group having 2 to 20 carbon atoms and 1 to 5 oxygen atoms. Preferably the 1-([2,2′-bithiophen]-5-yl)piperidine has 3 or fewer substituents, more preferably 1 substituent and most preferably no substituents.

### C₂-C₁₂ Dialkyl Amine

A C₂-C₁₂ dialkyl amine which is bonded to the xanthene core at the amine nitrogen, and is optionally substituted with 1 to 3 substituents selected from an alkenyl group having 2 to 10 carbon atoms, an alkynyl group having 2 to 10 carbon atoms, an alkoxy group having 1 to 20 carbon atoms, an alkylether group having 2 to 20 carbon atoms and 1 to 5 oxygen atoms, an aryl group having 6 to 10 carbon atoms, and a heterocyclic group having 3 to 16 carbon atoms. Preferably, the C₂-C₁₂ dialkyl amine has 1 substituent and most preferably no substituents.

### Indolizin-3-yl

Indolizin-3-yl which is bonded to the xanthene core at the 3-position and is substituted or unsubstituted. Preferably, the indolizine-3-yl donor is substituted with 1 to 3 substituents which are independently selected from halogen, sulfonate, hydroxy, amino, nitro, cyano, carboxy, an alkyl group having 1 to 20 carbon atoms, an alkenyl group having 2 to 20 carbon atoms, an alkynyl group having 2 to 20 carbon atoms, an aryl group having 6 to 10 carbon atoms, a heterocyclic group having 3 to 16 carbon atoms, an alkoxy group having 1 to 20 carbon atoms, and an alkylether group having 2 to 20 carbon atoms and 1 to 5 oxygen atoms. Preferably, the indolizine-3-yl donor has 3 or fewer substituents; even more preferably the indolizine-3-yl donor is substituted at the 1- and 2-positions with an alkyl group having 1 to 5 carbons and an aryl group having 6 to 10 carbon atoms; and even more preferably, the indolizine-3-yl donor is substituted at the 1-position with an alkyl group having 1 to 4 carbon atoms and at the 2-position with an aryl group having 6 to 8 carbon atoms; and most preferably, the indolizine donor is 1-methyl-2-phenylindolizin-3-yl.

### Diphenylamine

The diphenylamine preferably has the following cationic structure (the corresponding nonionic structure is not shown):

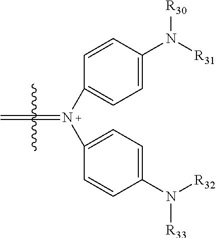

wherein R₃₀, R₃₁, R₃₂, and R₃₃ are independently selected from hydrogen, an alkyl group having 1 to 20 carbons, an alkenyl group having 2 to 20 carbon atoms, an alkynyl group having 2 to 20 carbon atoms, an alkoxy group having 1 to 20 carbon atoms, an alkylether group having 2 to 20 carbon atoms and 1 to 5 oxygen atoms, and an aryl group having 6 to 10 carbon atoms, at least one combination of (R₃₀ and R₃₁) and (R₃₂ and R₃₃) together with N forming a substituted or unsubstituted pyrrolidine ring, a substituted or unsubstituted piperidine ring, a substituted or unsubstituted morpholine ring, a substituted or unsubstituted tetrahydropyridine ring or a substituted or unsubstituted cyclohexylamine ring.

### Julolidine

Julolidine preferably has the following cationic structure (the corresponding nonionic structure is not shown):

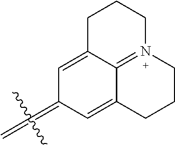

Julolidine is optionally substituted with 1 to 3 substituents independently selected from a halogen, sulfonate, hydroxy, amino, nitro, cyano, carboxy, an alkyl group having 1 to 20 carbon atoms, an alkenyl group having 2 to 20 carbon atoms, an alkynyl group having 2 to 20 carbon atoms, an alkoxy group having 1 to 20 carbon atoms, an alkylether group having 2 to 20 carbon atoms and 1 to 5 oxygen atoms, an aryl group having 6 to 10 carbon atoms, and a heterocyclic group having 3 to 16 carbon atoms. Preferably, the julolidine donor is not substituted or has one substituent.

The wavy line [symbol] is refers to the location of the bond between the donor and the xanthene core structure.

### Pharmaceutically Acceptable Carriers and Biocompatibility

In various aspects, the dyes of the present disclosure can be given to a patient in a biocompatible composition in an amount effective to allow for PA or Fl analysis of a particular tissue, organ or system. As used herein, “biocompatible” refers to a material or composition that does not cause harm to living tissue. In one aspect, the SWIR dyes disclosed herein are biocompatible. Herein, the term “biocompatible” is used interchangeably with “pharmaceutical” or “pharmaceutically acceptable”. As used herein, “pharmaceutically acceptable carriers” means one or more of a pharmaceutically acceptable diluents, preservatives, antioxidants, solubilizers, emulsifiers, coloring agents, releasing agents, coating agents, sweetening, flavoring and perfuming agents, and adjuvants.

In another aspect, the present disclosure relates to pharmaceutical compositions suitable for parenteral administration, such as intravenous administration, although the most suitable route in any given case will depend on the particular host, and nature and severity of the conditions for which the SWIR dyes are being administered for imaging.

In various aspects, the present disclosure also relates to a pharmaceutical composition comprising a pharmaceutically acceptable carrier or diluent and an effective amount of the SWIR dye compounds of the present disclosure for bioimaging, a product of the method of the disclosure, a pharmaceutically acceptable salt thereof, a hydrate thereof, a solvate thereof, a polymorph thereof, or a stereochemically isomeric form thereof. In a further aspect, the compounds of the present disclosure, a product of the method of the disclosure, a pharmaceutically acceptable salt thereof, a hydrate thereof, a solvate thereof, a polymorph thereof, or a stereochemically isomeric form thereof, or any subgroup or combination thereof may be formulated into various pharmaceutical forms for administration purposes.

Pharmaceutical compositions of the present disclosure suitable for parenteral administration can include sterile aqueous or oleaginous solutions, suspensions, or dispersions. Furthermore, the compositions can be in the form of sterile powders for the extemporaneous preparation of such sterile injectable solutions or dispersions. In some aspects, the final injectable form is sterile and must be effectively fluid for use in a syringe. The pharmaceutical compositions should be stable under the conditions of manufacture and storage; thus, preferably should be preserved against the contaminating action of microorganisms such as bacteria and fungi. The carrier can be a solvent or dispersion medium containing, for example, water, ethanol, polyol (e.g., glycerol, propylene glycol and liquid polyethylene glycol), vegetable oils, and suitable mixtures thereof.

Injectable solutions, for example, can be prepared in which the carrier comprises saline solution, such as a HEPES Buffered Saline or similar solutions.

As used herein, “nontoxic” refers to a material or composition that does not kill cells or organisms. In a further aspect, the SWIR dyes disclosed herein are nontoxic.

### Absorbance and Fluorescence of SWIR Dyes

In terms of brightness, luminosity is dependent on the extinction coefficient (molar absorptivity) of the fluorophores or their ability to absorb light, and the quantum efficiency or effectiveness at transforming absorbed light into emitted luminescence. The SWIR dyes themselves are not very fluorescent, but they are sufficiently fluorescent for brightness imaging. For instance, when the SWIR dye binds to proteins, the protein becomes more easily detectable.

### Methods for Making SWIR Dyes

In an aspect, the disclosure relates to a method for making SWIR dyes, the method comprising:
(a) performing a C—H arylation reaction by combining a Donor and an Acceptor of Formula II with a catalyst in a solvent to form a reaction mixture,

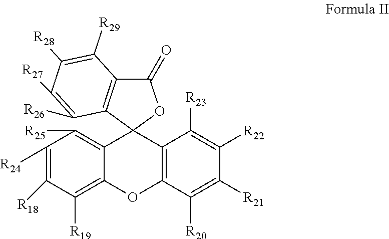

wherein R₁₈ and R₂₁ are individually selected from Cl, Br, I and OSO₂R₅₂ and R₅₂ is a hydrogen or lower alkyl;
wherein R₁₉, R₂₀, R₂₂, R₂₃, R₂₄, R₂₅, R₂₆, R₂₇, R₂₈, and R₂₉ are each independently selected from hydrogen or an alkyl group having 1 to 20 carbon atoms, or wherein one or more pair(s) of R₂₂ and R₂₃, R₂₄ and R₂₅, R₂₅ and R₂₆, R₂₆ and R₂₇, R₂₇ and R₂₈, R₂₈ and R₂₉, together with the carbons they are attached form a saturated or unsaturated 6 membered ring; and
wherein the Donor(s) is substituted or unsubstituted and comprises:
group (X) selected from dibenzazepinyl, thienyldibenzazepine, bithienyldibenzazepine, thienodibenzazepine, dihydrodibenzazepinyl, thienyldihydrodibenzazepine, bithienyldihydrodibenzazepine, and thienodihydrodibenzazepine; and
group (Y) selected from dibenzazepinyl, thienyldibenzazepine, bithienyldibenzazepine, thienodibenzazepine, dihydrodibenzazepinyl, thienyldihydrodibenzazepine, bithienyldihydrodibenzazepine, thienodihydrodibenzazepine, 1-(thiophen-2-yl)piperidine, 1-(thieno[3,2-b]thiophen-2-yl)piperidine, 1-([2,2′-bithiophen]-5-yl)piperidine, C₂-C₁₂ dialkyl amine, indolizine, diphenylamine, and julolidine,
to thereby replace the groups at R₁₈ and R₂₁ with said Donor(s);
(b) a ring opening reaction by transesterification with an alcohol to give the SWIR dye of formula I

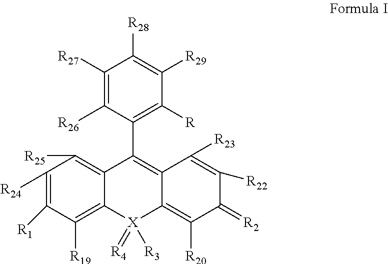

wherein X is O, R₃ and R₄ are absent;
R is selected from —C(O)OH or an ester group represented by the formula —C(O)OA¹, wherein A¹ is a linear or branched C₁-C₁₈ alkyl group;
R₁₉, R₂₀, R₂₂, R₂₃, R₂₄, R₂₅, R₂₆, R₂₇, R₂₈, and R₂₉ are as described above; and
R₁ and R₂ are independently selected from one of the following Groups B and C:

### Group B

Both R₁ and R₂ are the same donors and both are substituted or unsubstituted, and are selected from dibenzazepinyl, thienyldibenzazepine, bithienyldibenzazepine, thienodibenzazepine, dihydrodibenzazepinyl, thienyldihydrodibenzazepine, bithienyldihydrodibenzazepine, and thienodihydrodibenzazepine; and

### Group C

R₁ and R₂ are different donors and R₁ is a donor which is substituted or unsubstituted and is selected from dibenzazepinyl, thienyldibenzazepine, bithienyldibenzazepine, thienodibenzazepine, dihydrodibenzazepinyl, thienyldihydrodibenzazepine, bithienyldihydrodibenzazepine, and thienodihydrodibenzazepine and R₂ is a donor which is substituted or unsubstituted and is selected from dibenzazepinyl, thienyldibenzazepine, bithienyldibenzazepine, thienodibenzazepine, dihydrodibenzazepinyl, thienyldihydrodibenzazepine, bithienyldihydrodibenzazepine, thienodihydrodibenzazepine, 1-(thiophen-2-yl)piperidine, 1-(thieno[3,2-b]thiophen-2-yl)piperidine, 1-([2,2′-bithiophen]-5-yl)piperidine, C₂-C₁₂ dialkyl amino, indolizine-3-yl, diphenylamino, and julolidinyl. In Group C, the dyes are unsymmetrical. For instance, the donor at R₁ could be thienyldibenzazepine and at R₂ could be thienodibenzazepine; or both R₁ and R₂ can be thienyldibenzazepine but one is substituted and the other is not.

Preferably, the compound formed in step (a) has the following structure:

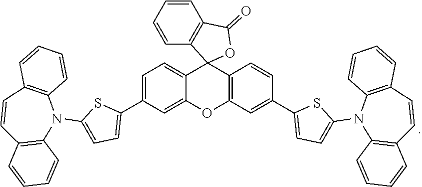 [SMILES: O=C1OC2(c3ccc(-c4ccc(N5c6ccccc6C=Cc6ccccc65)s4)cc3Oc3cc(-c4ccc(N5c6ccccc6C=Cc6ccccc65)s4)ccc32)c2ccccc21]

In one aspect, the solvent in step (a) is selected from N-methyl-2-pyrrolidone (NMP), N,N-dimethylacetamide (DMA), dimethylformamide (DMF), toluene, tetrahydrofuran (THF), dioxane, and any combination thereof.

In one aspect, in step (a), the reaction mixture is heated at a temperature from about 80° C. to about 150° C., or at about 80° C., 85° C., 90° C., 95° C., 100° C., 105° C., 110° C., 115° C., 120° C., 125° C., 130° C., 135° C., 140° C., 145° C., or about 150° C., or a combination of any of the foregoing values, or a temperature within a range encompassing any of the foregoing values. In another aspect, the reaction mixture can be heated for from about 6 hours to about 30 hours, or for about 6 hours, 6.5 hours, 7 hours, 7.5 hours, 8 hours, 8.5 hours, 9 hours, 9.5 hours, 10 hours, 11 hours, 12 hours, 13 hours, 14 hours, 15 hours, 16 hours, 17 hours, 18 hours, 19 hours, 20 hours, 21 hours, 22 hours, 23 hours, or about 24 hours, or a combination of any of the foregoing values, or for a time within a range encompassing any of the foregoing values. In one aspect, step (a) can be conducted in an inert atmosphere such as, for example, nitrogen.

In one aspect, step (a) further includes admixing a catalyst with the compound of Formula II and the Donor. The catalyst can be bis(triphenylphosphine)palladium(II) dichloride (PdCl₂(PPh₃)₂), Palladium(II)acetate (Pd(OAc)₂), tris(dibenzylideneacetone)dipalladium(0) (Pd(dba)₃)CHCl₃, or any combination thereof. In a further aspect, from about 0.01 to about 0.1 moles of catalyst can be used per mole of compound of Formula II. Further in this aspect, about 0.01, 0.02, 0.03, 0.04 or about 0.05 moles of catalyst can be used, or a combination of any of the foregoing values, or an amount within a range encompassing any of the foregoing values.

In another aspect, step (a) further includes admixing a base with the compound of Formula II and the Donor. In still another aspect, the base can be potassium acetate (KOAc), sodium acetate (NaOAc), Cs₂CO₃, KO^{t}Bu, NaO^{t}Bu, K₂CO₃, Na₂CO₃, or any combination thereof. In one aspect, from about 2.0 moles to about 6.0 moles of base can be used per mole of compound of Formula II. Further in this aspect, about 2.0, 2.7, 3.0, 3.2, or about 3.3 moles to about 6.0, 5.5, 5.0, or about 4.5 moles of base can be used, or a combination of any of the foregoing values, or a number of moles within a range encompassing any of the foregoing values.

In still another aspect, step (a) further includes admixing a ligand with the compound of Formula II and the Donor compound. In a further aspect, the ligand can be triphenylphosphine (PPh₃), Dicyclohexyl[2′,4′,6′-tris(propan-2-yl)[1,1′-biphenyl]-2-yl]phosphane (Xphos), 2,2′-bis(diphenylphosphino)-1-1′-binaphthyl (BINAP), (^{t}Bu)₂PMeHBF₄, or any combination thereof. In an aspect, from about 1 to about 4 moles of ligand can be used per mole of catalyst, or about 1.5 to about 2.5, or about 2 moles of ligand per mole of catalyst can be used, or a combination of any of the foregoing values, or a number of moles within a range encompassing any of the foregoing values.

In an aspect, in step (b), the alcohol used in the transesterification reaction is also a solvent or cosolvent. The alcohol may be selected from methanol, ethanol, propanol, isopropanol, and butyl alcohol. In an aspect, the reaction mixture is heated to reflux. In another aspect, the reaction mixture can be heated for from about 6 hours to about 24 hours, or for about 6, 6.5, 7, 7.5, 8, 8.5, 9, 9.5, 10, 11, 12, 13, 14, 15, 16, 17, 18, 19, 20, 21, 22, 23, or about 24 hours, or a combination of any of the foregoing values, or for a time within a range encompassing any of the foregoing values. In one aspect, step (b) can be conducted in an inert atmosphere such as, for example, nitrogen.

As noted above, the donors can be symmetrical or unsymmetrical in a D-A-D designed molecule. For symmetrical dyes, such as XanthCR-880, the donor is combined with the acceptor using twice the moles of the donor when compared to the moles of acceptor. On the other hand, an SWIR dye having an unsymmetrical D1-A-D2 design could be prepared by essentially the same synthesis except that some of the DI reactants are replaced with D2 reactants, such that: the total moles (D1+D2) is twice the moles of A. In addition, SWIR dyes having R₁═H could be made by starting with an acceptor having only one leaving group and using equimolar amounts of acceptor and donor.

Also disclosed are SWIR dyes produced by the disclosed methods.

### Compositions, Methods, and Devices Using the SWIR Dyes

In one aspect, disclosed herein is a composition including an SWIR dye disclosed herein and which optionally includes a carrier. In a further aspect, the carrier can be a pharmaceutically acceptable carrier. In still another aspect, the compositions can be biocompatible and/or nontoxic.

Also disclosed herein are methods for imaging a biological sample. In one aspect, the method includes the steps of (a) contacting the biological sample with a disclosed composition; (b) exposing the biological sample and the composition to SWIR radiation; and (c) observing PA emission in the biological sample. In a further aspect, the biological sample includes an organelle, a cell, a tissue, an organ, or any combination thereof.

Other potential applications include composites comprising the dyes in a polymer matrix for commodity items such as eyeglasses, night vision glasses or smart glasses, sensors, laser, and optoelectronic materials for electrical devices.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

The following examples are put forth so as to provide those of ordinary skill in the art with a complete disclosure and description of how the compounds, compositions, articles, devices and/or methods claimed herein are made and evaluated and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in 20° C.-22° C. or is at ambient temperature, and pressure is at or near atmospheric.

All chemicals and solvents were purchased from commercial suppliers and used without further purification unless other-wise specified. Tetrahydrofuran (THF), isopropyl alcohol (IPA), and hydrogen peroxide (H2O2, 30% w/v) were purchased from Macron Fine Chemicals. IR-1061, acetaminophen (APAP), potassium superoxide, tert-butyl hydroperoxide, and tetrakis(acetonitrile)copper(I) hexafluorophosphate were purchased from Sigma-Aldrich. mDSPE-PEG MW 5,000 was purchased from Laysan Bio. Sodium chloride, 50K centrifugal filters, and Mohr's salt were purchased from MilliporeSigma. DEA-NONOate was purchased from Cayman Chemical. 1× phosphate saline buffer (Corning) was purchased from Thermo-Fisher Scientific. 25 mM HEPES and L-cysteine were purchased from Oakwood Chemical. Glutathione (reduced) was purchased from Acros Organics Chemicals. Isopentyl nitrite was purchased from Alfa Aesar Chemicals. Thieno[3,2-b]thiophene, 2-bromothiophene, 5-bromo-2,2′-bithiophene, and 5H-dibenzo[b,f]azepine were purchased from Sigma Aldrich or Fisher Scientific and used directly without further purification.

Thiophene (SCR-1), thienothiophene (SCR-2), and bithiophene (SCR-3) were incorporated into xanthene dye structures. The synthesis of the dyes began with the C—N cross-coupling of the dibenzazepine core with the corresponding bromothiophene derivatives (see Schemes 1-3 below), followed by a direct diarylation reaction with 3′,6′-dibromofluoran. From here, the dyes were trapped into the opened form by converting them to the corresponding ethyl ester, giving rise to SCR-1, SCR-2, and SCR-3. It is noteworthy that the synthesis of the dyes occurs in three steps from the bromothiophene derivatives.

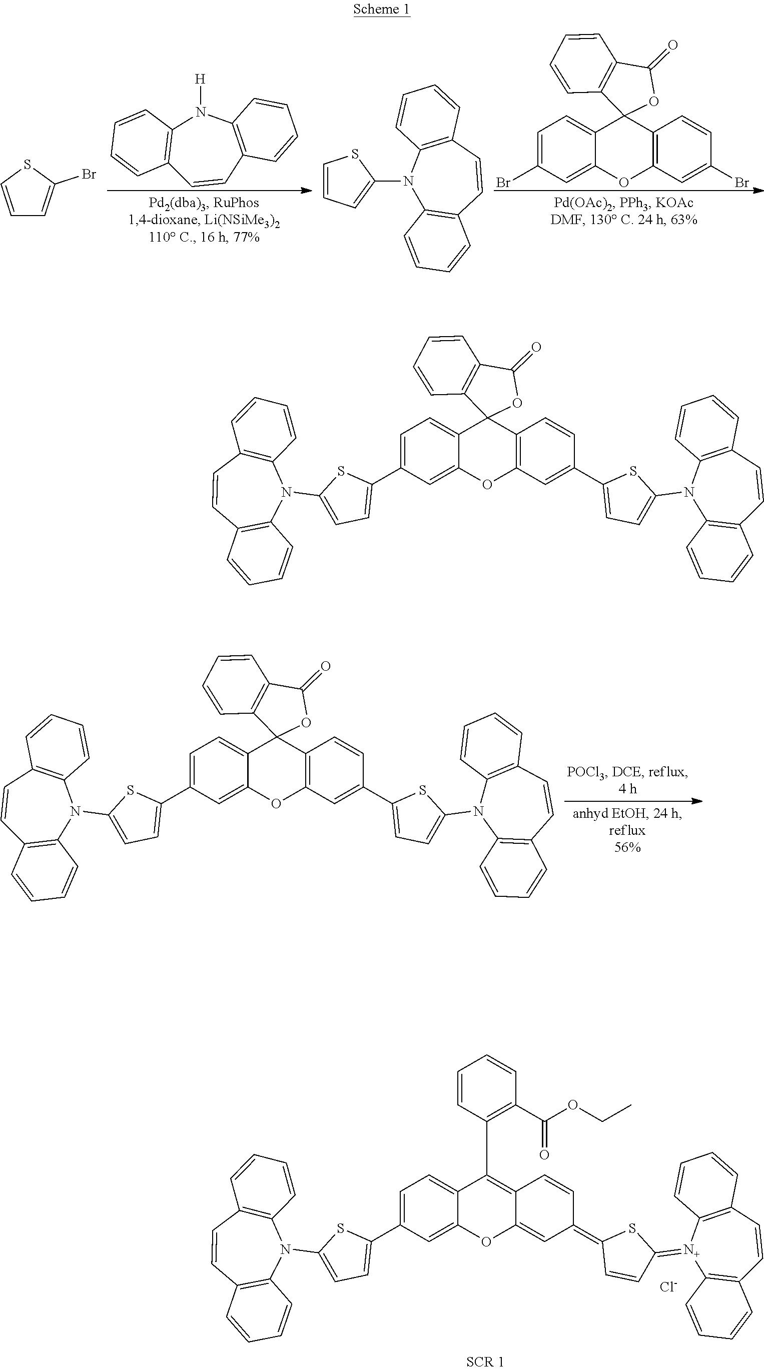

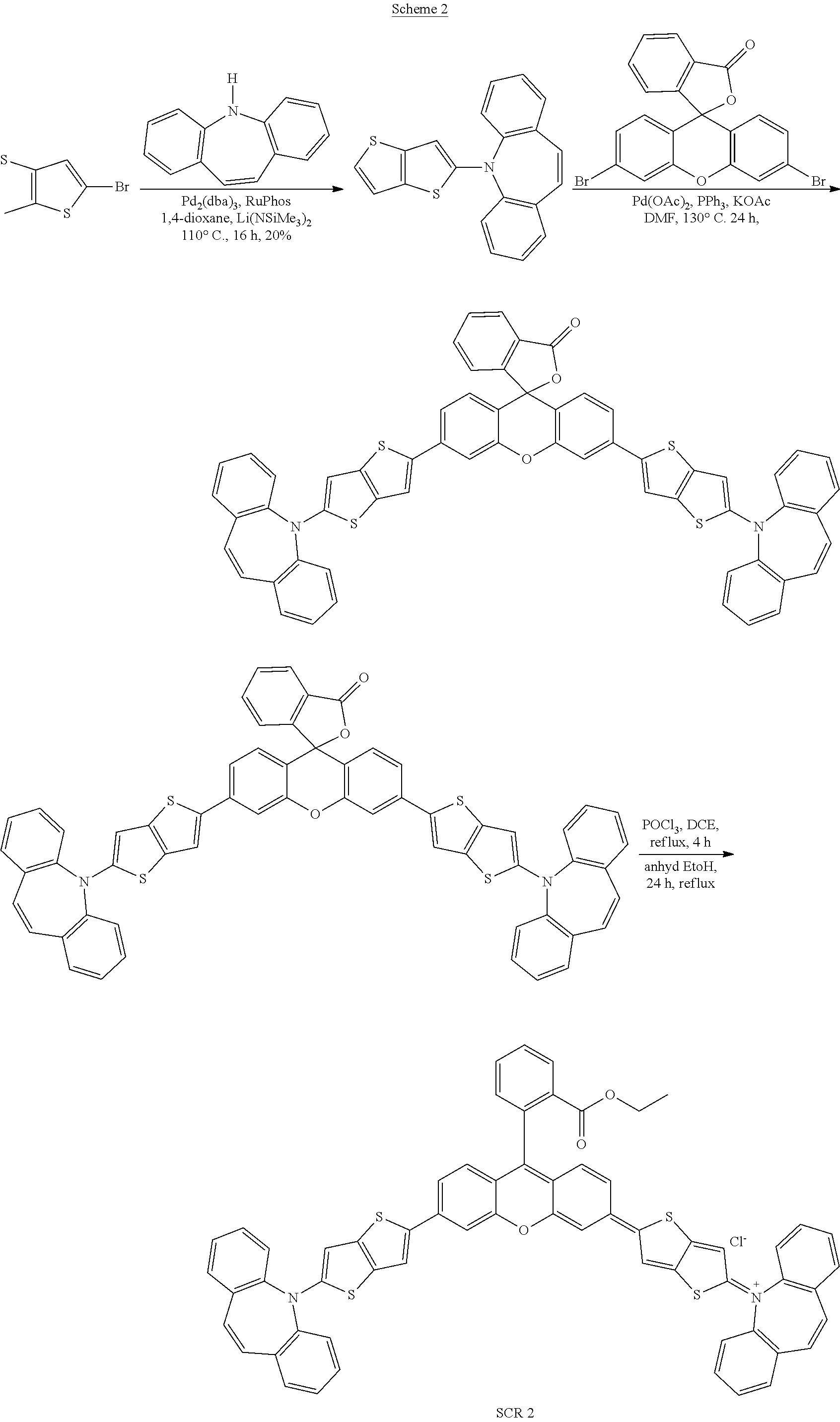

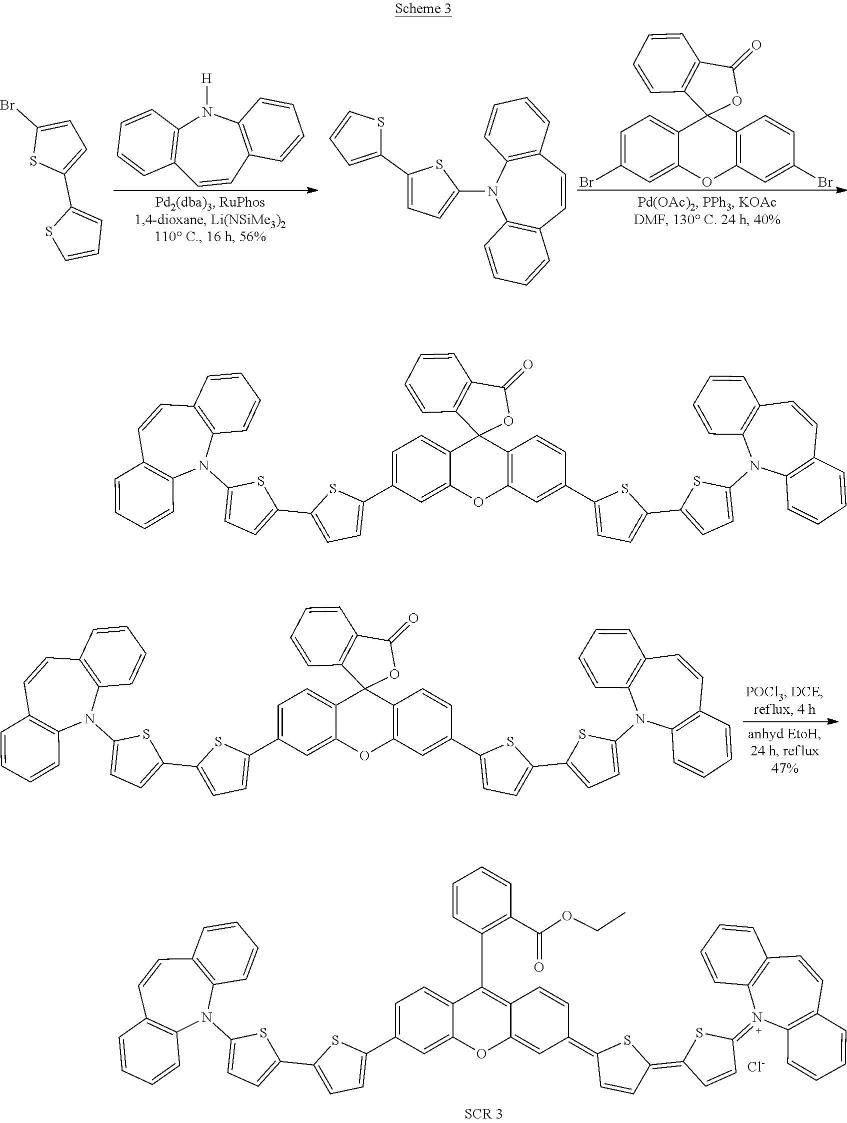

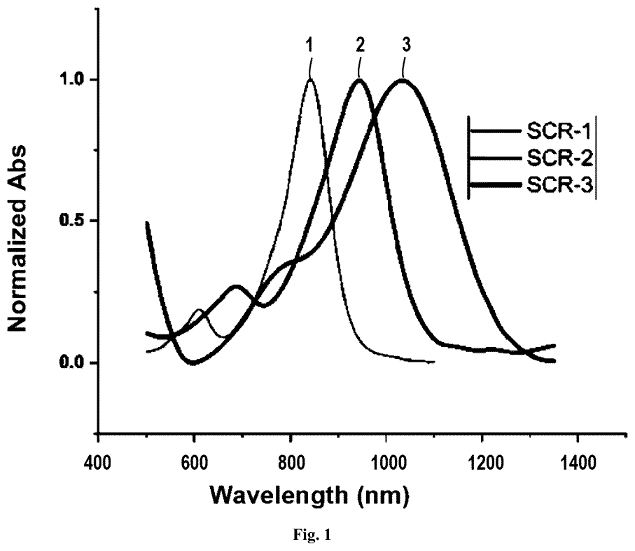

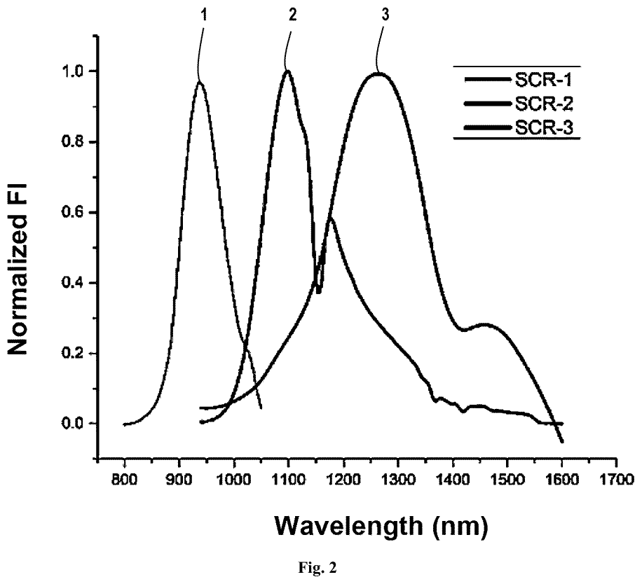

An assessment of the photophysical properties of SCR-1, SCR-2, and SCR-3 in dichloromethane (DCM) revealed the absorption and emission bands of all three dyes extended well into the NIR to SWIR region, thus fulfilling the primary design objective (FIGS. 1 and 2, Table 1). The quantum yield (QY) of the dyes decreased as the absorption wavelength increased, which is common to these dyes. However, it is worth noting that the Stokes shift also increased with the conjugation length.

TABLE 1
Photophysical properties of SCR-1, SCR-2, and SCR-3

| | λ_{abs} | λₑₘ | QY | Stokes | ε |
|---|---|---|---|---|---|
| Dyes | (nm) | (nm) | (%) | Shift | (M⁻¹cm⁻¹) × 10⁵ |
| SCR-1 | 840 | 950 | 0.31 | 110 | 1.20 |
| SCR-2 | 950 | 1100 | 0.036 | 150 | 1.24 |
| SCR-3 | 1040 | 1260 | 0.016 | 220 | 0.80 |

### Nitrous Oxide Nanosensor

An aspect of the invention is NO-responsive molecules, an example of which is SCR-NO that used the SCR scaffold.

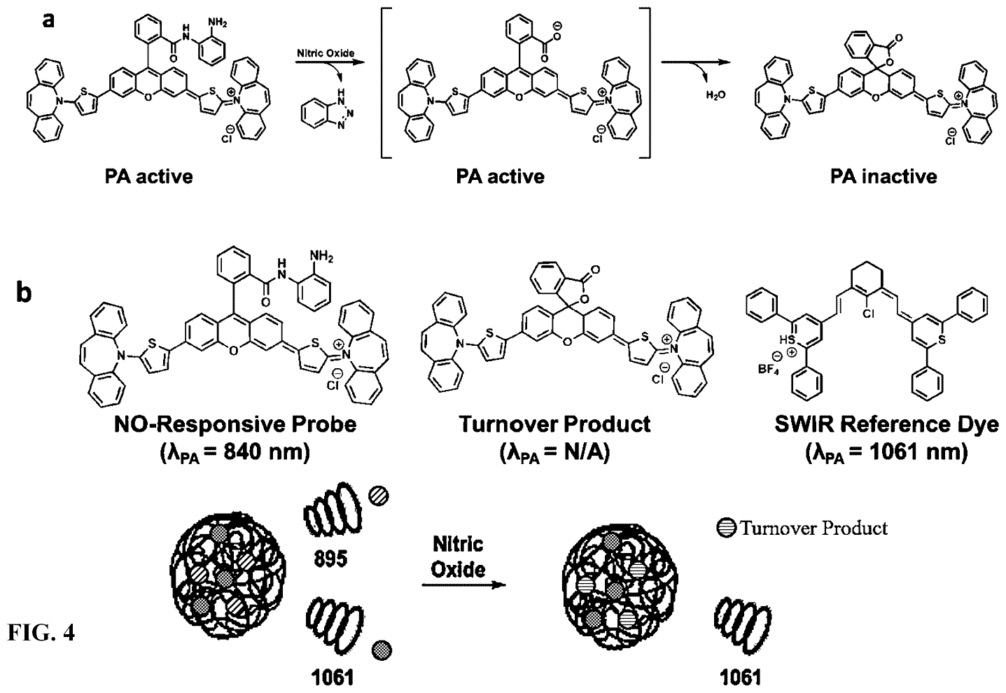

The NO reactive species, SCR-NO (see the first PA-Active species in FIG. 4, image a)), was formed using an SCR dye with an NO-responsive unit (i.e., o-phenylenediamine trigger), thus locking the molecule in its ‘open’ PA-active form. The reaction with NO (via the active species N₂O₃) would then generate an acyl triazole intermediate that can undergo spontaneous rate-limiting hydrolysis to yield the free dye. After this cleavage event, the dye could immediately close to the PA—inactive lactone form (see FIG. 4). Having developed SCR-NO, a second SWIR-absorbing dye that does not respond to NO to serve as an internal reference was used. The internal reference, SWIR Reference Dye (IR-1061) was chosen because it had NO-stability and exhibited minimal spectral overlap with SCR-NO to enable ratiometric calibration.

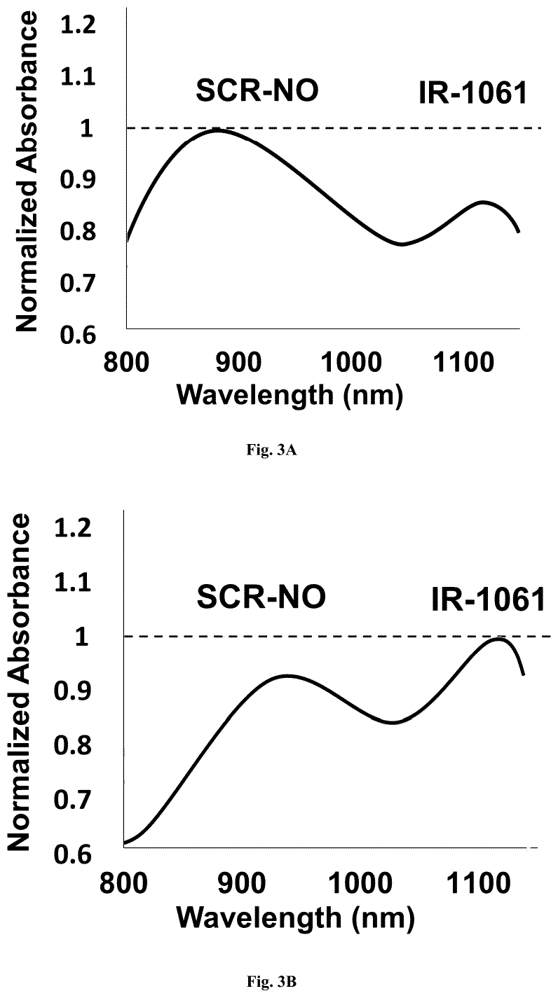

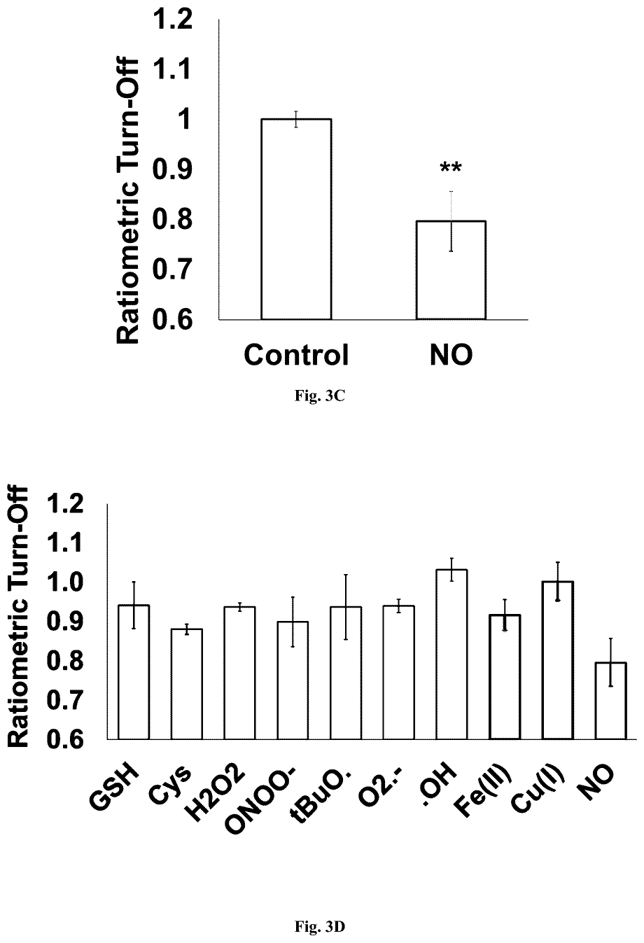

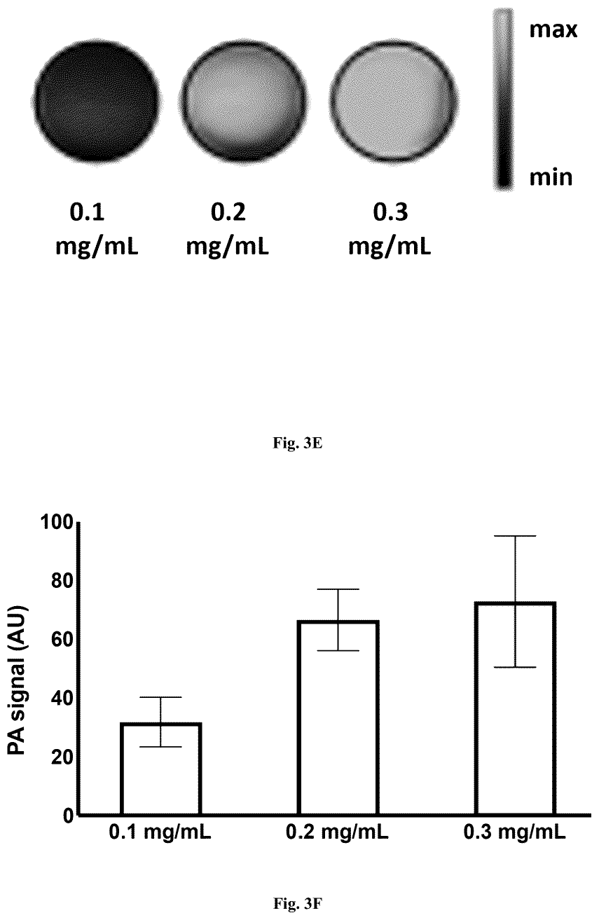

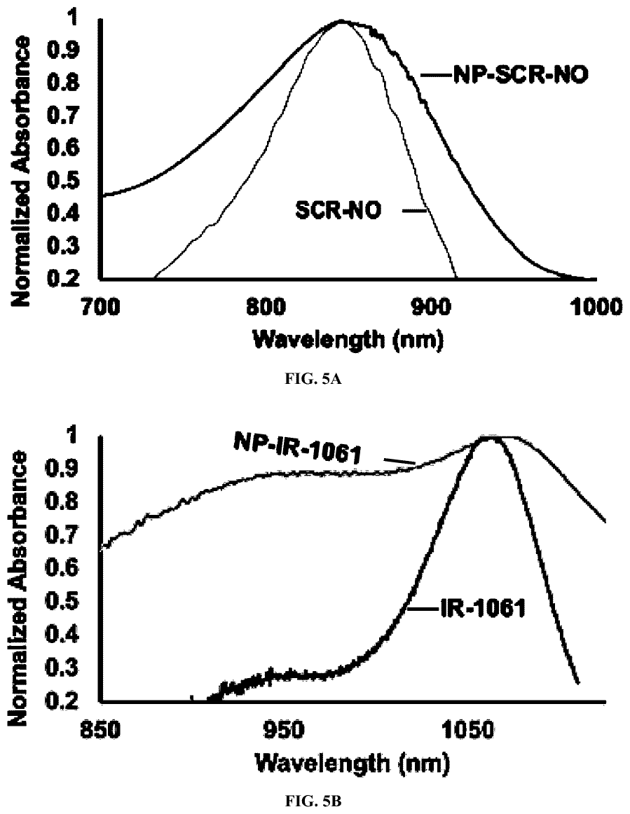

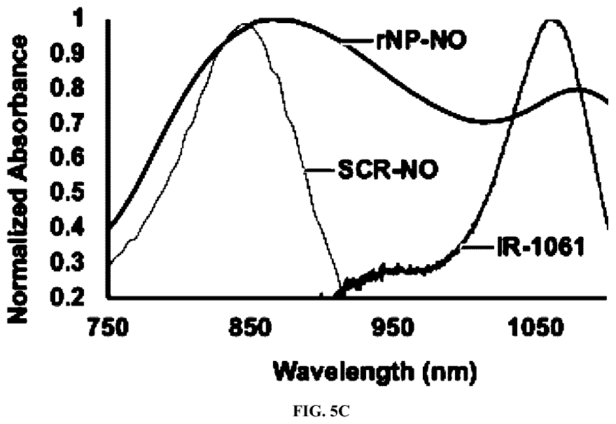

To ensure the relative ratio of the probe and reference remained constant, a nanoparticle (NP) system that demonstrates minimal leaching of the encapsulated dye components was used. Moreover, the NP would ideally display excellent biocompatibility, display sufficient permeability to allow NO to diffuse into the core to access the encapsulated probe, and exhibit intrinsic liver targeting. The SCR-NO and IR-1061 were encapsulated using DSPE-PEG (a common phospholipids-polymer conjugate) to give NP-SCR-NO and NP-IR-1061, respectively. Both sets of NPs showed the predicted absorbance properties, where the spectra in water were similar to the un-encapsulated parent molecules in organic solvent (FIGS. 5A-5C). However, when the components were co-encapsulated (rNP-NO, ratiometric NP for NO), there was observed a favorable ˜100 nm red-shift of the SCR-NO λ_{abs} into the SWIR region (FIG. 3A). The corresponding change for IR-1061 was minimal (1 nm).

Next, the baseline stability of the NPs was tested. Each solution was found to be stable, as no change in the absorbance intensity was observed compared to the initial time point over several days. However, when rNP-NO was treated with NO, the signal corresponding to the probe decreased while the signal from the reference remained unchanged (FIG. 3B). The ratiometric turn-on, defined as ratio of λ_{SCR-NO}/λ_{IR-1061}, changed from 1.00±0.02 to 0.79±0.06 after reaction with NO (FIG. 3C). Together, the results indicate the chosen 1,2-distearoyl-sn-glycero-3-phosphoethanolamine-poly(ethylene glycol) (DSPE-PEG) matrix imparts sufficient NP stability and is permeable to NO.

Beyond NO treatment, the rNP-NO were subjected to a panel of biologically relevant analytes found in the liver (FIG. 3D). For example, glutathione is present at concentrations in the mM range where it functions as an antioxidant to help the body remove toxins. When rNP-NO was treated with GSH at a concentration of 5 mM, no significant change in the λ_{SCR-NO}/λ_{IR-1061} was observed. The same results were found when cysteine, another thiol containing amino acid, was examined at 100 μM. Next, rNP-NO was incubated with various reactive oxygen species (ROS) including hydrogen peroxide, peroxynitrite, tert-butyl hydrogen peroxide, superoxide, and hydroxyl radical. No evidence of probe decomposition was observed. This is an unexpected advantage, since many dye platforms are prone to oxidative decomposition, especially in the presence of highly reactive molecules like hydroxyl radical. Lastly, the stability of rNP-NO against iron and copper was evaluated, which can generate reactive oxygen species (ROS) via Fenton and Fenton-like chemistry, respectively. The λ_{SCR-NO}/λ_{IR-1061} ratio was again unaffected. Together, these results demonstrate that besides reactivity with NO, rNP-NO would be stable to conditions found in the liver when administered to live animals.

### In Vitro Assessment of PA Properties

One determinant of a strong PA signal is the magnitude of the extinction coefficient (EC) of a molecule. This often supersedes the quantum yield (QY) since the former of these two terms dominates the PA brightness value (EC×(1−QY)). With a calculated value of 8.28×10⁴ M⁻¹cm⁻¹ for SCR-1, it was anticipated that strong ultrasound waves will be produced upon irradiation of rNP-NO. To test this, dense tissue-mimicking phantoms comprised of milk and agar were formulated. Individual samples containing each of the NPs were inserted to perform PA imaging. In the case of NP-SCR-NO, a PA signal was observed only when excited at the probe wavelength. Similarly, a PA signal originating from IR-1061 irradiation was the only ultrasound source from NP-IR-1061. However, PA signals were recorded for both the probe and reference when rNP-NO was subjected to the same in vitro test. As can be seen in FIGS. 3E and 3F, there was a dose-dependent increase in the PA intensity as the NP concentration increases; however, the ratio of λ_{SCR-NO}/λ_{IR-1061} remained unchanged.

### Evaluation of rNP-NO in a Murine Model of Drug-Induced Liver Injury

For in vivo testing of rNP-NO in live mice, an advanced MSOT (multispectral optoacoustic (photoacoustic) tomography) system was employed to track rNP-NO. PA imaging was performed using the MSOT because: 1) it can be used to visualize the entire animal (including the liver) and present the processed PA images in an easy-to-interpret cross-sectional view; 2) signals from the probe (SCR-NO) and reference dye (IR-1061) can be readily isolated from each other, as well as from interfering endogenous PA-active pigments via spectral unmixing; and 3) it can rapidly switch between the two SWIR wavelengths to facilitate ratiometric calibration. It is noteworthy that the ratiometric feature of rNP-NO is superior to systems where monitoring occurs at a single wavelength. First, a cohort of BALB/c mice (female 6-8-weeks old) were treated with a solution of rNP-NO (3-4 mg/mL) via systemic administration (intraperitoneal (i.p.) injection). The biodistribution profile was determined by tracking rNP-NO circulation at two wavelengths. Within 15 minutes, rNP-NO had predominately localized to the liver.

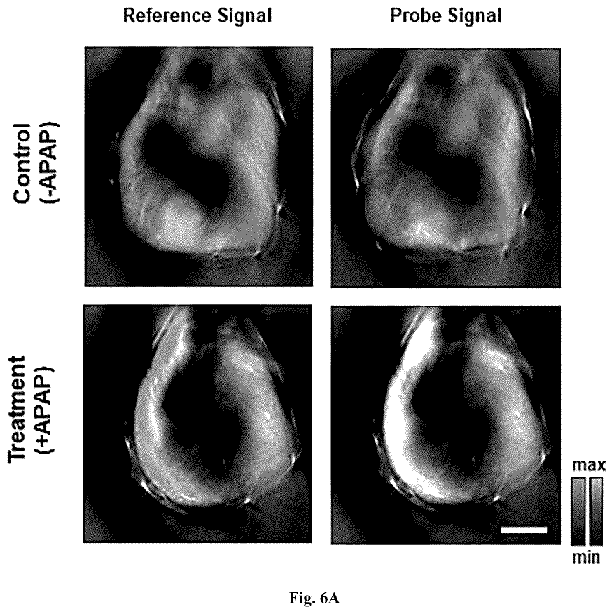

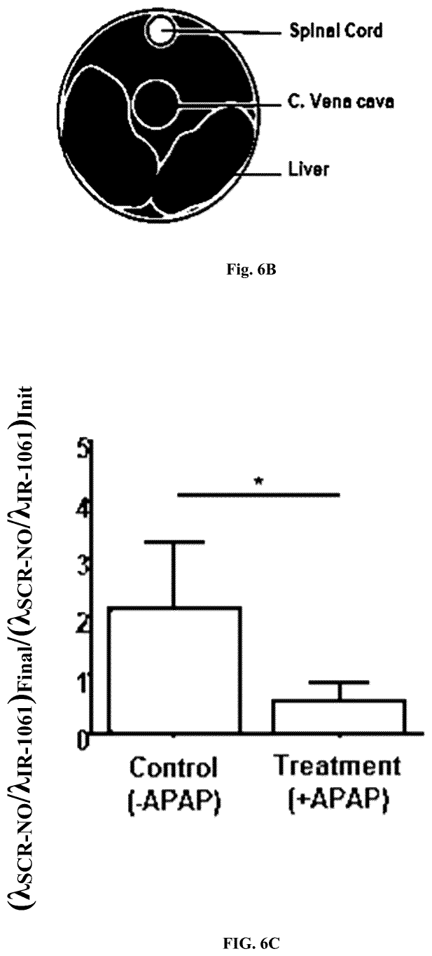

Next, the utility of the nanosensor in a drug-induced liver injury (DILI) model was established. Drug-induced liver injury (DILI) is responsible for 60% of acute liver failure cases in the United States and is notoriously difficult to diagnose. Visualizing molecular level changes in the liver during DILI allows for early intervention and is an important step toward deciphering the mechanistic underpinnings of the disease. For example, NO is believed to contribute to the progression of DILI due to the upregulation of inducible nitric oxide synthases in hepatocytes. Moreover, it is one of the earliest indicators of liver failure as the immune response is rapidly and aggressively activated. By injecting BALB/c mice with acetaminophen (APAP), a drug known to cause DILI when given at high doses, it was reasoned that reliable monitoring of the overproduction of NO could be obtained using rNP-NO and SWIR PA imaging. Mice selected to generate the DILI model were intraperitoneal injection (i.p.) injected with a solution (200 μL) of APAP at a dose of 300 mg/kg. In contrast, mice belonging to the control group were injected with the same volume of 0.9% saline. Then 16 hours were allowed to lapse thereby giving the mice time to succumb to DILI before rNP-NO was administered for SWIR PA imaging. Interestingly, the SWIR PA signal from the reference dye was localized to the liver for both groups and the overall signal intensity (color coded in green) was nearly identical (FIG. 6A, shown below). However, the SWIR PA signal from the probe could only be seen in the liver of the control animals and was clearly absent in the mice treated with APAP (FIG. 6B). Specifically, the (λ_{SCR-NO}/λ_{IR-1061})_{Final}/(λ_{SCR-NO}/λ_{IR-1061})_{Init} ratio for the control group was determined to be 2.13±1.15, whereas the corresponding ratio from the APAP treated cohort decreased to 0.56±0.31 (FIG. 6C). This result indicates that NO production was indeed upregulated in response to DILI and our probe exhibited sufficient sensitivity to detect this change.

### CONCLUSION

C—H activation chemistry was employed to develop a panel of synthetically accessible SWIR dyes and to highlight their utility for in vivo activity-base sensing by developing a SWIR PA nanosensor. By incorporating a dibenzazepine donor conjugated to thiophene (SCR-1), thienothiophene (SCR-2), and bithiophene (SCR-3) moiety, the absorbance band of the resulting xanthene dyes bathochromically shifted into the SWIR region. Capping of the pendant carboxylate group of SCR-1 with an NO-responsive unit resulted in SCR-NO, which remained open prior to encountering NO. This probe was able to stay “on” or turn “off” to design rNP-NO. When encapsulated, the SCR-NO dye resulted in a bathochromic shift to the SWIR region. Co-encapsulation of SCR-NO with IR-1061 as the internal reference dye allowed for a large dynamic range and reliable ratiometric confirmation of NO sensing. This is highlighted in the series of in vitro studies described above as well as in an in vivo DILI model, where rNP-NO was able to differentiate between mice primed for liver damage using APAP versus a saline control. The use of SWIR to monitor the probe and internal reference assures that the PA signals are originating from a deep region of the liver. Beyond activity-based sensing, the SCR panel of SWIR dyes can be readily transformed into contrast agents by capping carboxylate with an alcohol to yield stable ester products. These SWIR molecules are useful in cancer treatment (e.g., SWIR PA surgical guidance).

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. It is noted that the dates of publication provided herein can be different from the actual publication dates, which can require independent confirmation.

Prior to describing the various aspects of the present disclosure, the following definitions are provided and should be used unless otherwise indicated. Additional terms may be defined elsewhere in the present disclosure.

### REFERENCES

All references cited herein are hereby incorporated by reference in their entirety as if fully set forth herein.
1. Weissleder, R., A clearer vision for in vivo imaging. Nature Biotechnology 2001, 19 (4), 316-317.
2. Frangioni, J. V., In vivo near-infrared fluorescence imaging. Current Opinion in Chemical Biology 2003, 7 (5), 626-634.
3. Agostinis, P.; Berg, K.; Cengel, K. A.; Foster, T. H.; Girotti, A. W.; Gollnick, S. O.; Hahn, S. M.; Hamblin, M. R.; Juzeniene, A.; Kessel, D.; Korbelik, M.; Moan, J.; Mroz, P.; Nowis, D.; Piette, J.; Wilson, B. C.; Golab, J., Photodynamic therapy of cancer: An update. CA: A Cancer Journal for Clinicians 2011, 61 (4), 250-281.
4. (a) Wang, X.; Pang, Y.; Ku, G.; Xie, X.; Stoica, G.; Wang, L. V., Noninvasive laser-induced photoacoustic tomography for structural and functional in vivo imaging of the brain. Nature Biotechnology 2003, 21 (7), 803-806; (b) Reinhardt, C. J.; Chan, J., Development of Photoacoustic Probes for in Vivo Molecular Imaging. Biochemistry 2018, 57 (2), 194-199.
5. Guo, Z.; Park, S.; Yoon, J.; Shin, I., Recent progress in the development of near-infrared fluorescent probes for bioimaging applications. Chemical Society Reviews 2014, 43 (1), 16-29.
6. (a) Schaafsma, B. E.; Mieog, J. S. D.; Hutteman, M.; van der Vorst, J. R.; Kuppen, P. J. K.; Löwik, C. W. G. M.; Frangioni, J. V.; van de Velde, C. J. H.; Vahrmeijer, A. L., The clinical use of indocyanine green as a near-infrared fluorescent contrast agent for image-guided oncologic surgery. Journal of Surgical Oncology 2011, 104 (3), 323-332; (b) Vahrmeijer, A. L.; Hutteman, M.; van der Vorst, J. R.; van de Velde, C. J. H.; Frangioni, J. V., Image-guided cancer surgery using near-infrared fluorescence. Nature Reviews Clinical Oncology 2013, 10 (9), 507-518.
7. Huang, X.; El-Sayed, I. H.; Qian, W.; El-Sayed, M. A., Cancer Cell Imaging and Photothermal Therapy in the Near-Infrared Region by Using Gold Nanorods. Journal of the American Chemical Society 2006, 128 (6), 2115-2120.
8. Alford, R.; Simpson, H. M.; Duberman, J.; Hill, G. C.; Ogawa, M.; Regino, C.; Kobayashi, H.; Choyke, P. L., Toxicity of Organic Fluorophores Used in Molecular Imaging: Literature Review. Molecular Imaging 2009, 8 (6), 7290.2009.00031.
9. Xiang, H.; Cheng, J.; Ma, X.; Zhou, X.; Chruma, J. J., Near-infrared phosphorescence: materials and applications. Chemical Society Reviews 2013, 42 (14), 6128-6185.
10. Zhao, J.; Zhong, D.; Zhou, S., NIR-I-to-NIR-II fluorescent nanomaterials for biomedical imaging and cancer therapy. Journal of Materials Chemistry B 2018, 6 (3), 349-365.
11. (a) Yamazawa, S.; Nakashima, M.; Suda, Y.; Nishiyabu, R.; Kubo, Y., 2,3-Naphtho-Fused BODIPYs as Near-Infrared Absorbing Dyes. The Journal of Organic Chemistry 2016, 81 (3), 1310-1315; (b) Staudinger, C.; Breininger, J.; Klimant, I.; Borisov, S. M., Near-infrared fluorescent aza-BODIPY dyes for sensing and imaging of pH from the neutral to highly alkaline range. Analyst 2019, 144 (7), 2393-2402.
12. (a) Umezawa, K.; Citterio, D.; Suzuki, K., Water-soluble NIR Fluorescent Probes Based on Squaraine and Their Application for Protein Labeling. Analytical Sciences 2008, 24 (2), 213-217; (b) Lambert, C.; Scherpf, T.; Ceymann, H.; Schmiedel, A.; Holzapfel, M., Coupled Oscillators for Tuning Fluorescence Properties of Squaraine Dyes. Journal of the American Chemical Society 2015, 137 (10), 3547-3557; (c) McNamara, L. E.; Rill, T. A.; Huckaba, A. J.; Ganeshraj, V.; Gayton, J.; Nelson, R. A.; Sharpe, E. A.; Dass, A.; Hammer, N. I.; Delcamp, J. H., Indolizine-Squaraines: NIR Fluorescent Materials with Molecularly Engineered Stokes Shifts. Chemistry—A European Journal 2017, 23 (51), 12494-12501; (d) Patwari, J.; Sardar, S.; Liu, B.; Lemmens, P.; Pal, S. K., Three-in-one approach towards efficient organic dye-sensitized solar cells: aggregation suppression, panchromatic absorption and resonance energy transfer. Beilstein Journal of Nanotechnology 2017, 8, 1705-1713.
13. (a) Sibrian-Vazquez, M.; Ortiz, J.; Nesterova, I. V.; Fernández-Lázaro, F.; Sastre-Santos, A.; Soper, S. A.; Vicente, M. G. H., Synthesis and Properties of Cell-Targeted Zn(II)-Phthalocyanine-Peptide Conjugates. Bioconjugate Chemistry 2007, 18 (2), 410-420; (b) Balaz, M.; Collins, H. A.; Dahlstedt, E.; Anderson, H. L., Synthesis of hydrophilic conjugated porphyrin dimers for one-photon and two-photon photodynamic therapy at NIR wavelengths. Organic & Biomolecular Chemistry 2009, 7 (5), 874-888.
14. (a) Dost, T. L.; Gressel, M. T.; Henary, M., Synthesis and Optical Properties of Pentamethine Cyanine Dyes With Carboxylic Acid Moieties. Analytical Chemistry Insights 2017, 12, 1177390117711938; (b) Shindy, H. A., Fundamentals in the chemistry of cyanine dyes: A review. Dyes and Pigments 2017, 145, 505-513; (c) Braun, A. B.; Wehl, I.; Kölmel, D. K.; Schepers, U.; Bräse, S., New Polyfluorinated Cyanine Dyes for Selective NIR Staining of Mitochondria. Chemistry—A European Journal 2019, 25 (34), 7998-8002.
15. Lu, Y.; Sun, Q.; Zhang, Z.; Tang, L.; Shen, X.; Xue, S.; Yang, W., New frog-type Dibenzo[a,c][1,2,5]thiadiazolo[3,4-i]phenazine heterocyclic derivatives with aggregation-enhanced one- and two-photon excitation NIR fluorescence. Dyes and Pigments 2018, 153, 233-240.
16. (a) Sun, Y.-Q.; Liu, J.; Lv, X.; Liu, Y.; Zhao, Y.; Guo, W., Rhodamine-Inspired Far-Red to Near-Infrared Dyes and Their Application as Fluorescence Probes. Angewandte Chemie International Edition 2012, 51 (31), 7634-7636; (b) Davies, K. S.; Linder, M. K.; Kryman, M. W.; Detty, M. R., Extended rhodamine photosensitizers for photodynamic therapy of cancer cells. Bioorganic & Medicinal Chemistry 2016, 24 (17), 3908-3917; (c) Rathnamalala, C. S. L.; Gayton, J. N.; Dorris, A. L.; Autry, S. A.; Meador, W.; Hammer, N. I.; Delcamp, J. H.; Scott, C. N., Donor-Acceptor-Donor NIR II Emissive Rhodindolizine Dye Synthesized by C—H Bond Functionalization. The Journal of Organic Chemistry 2019, 84 (20), 13186-13193; (d) Wang, L. G.; Munhenzva, I.; Sibrian-Vazquez, M.; Escobedo, J. O.; Kitts, C. H.; Fronczek, F. R.; Strongin, R. M., Altering Fundamental Trends in the Emission of Xanthene Dyes. The Journal of Organic Chemistry 2019, 84 (5), 2585-2595.
17. Fukazawa, A.; Suda, S.; Taki, M.; Yamaguchi, E.; Grzybowski, M.; Sato, Y.; Higashiyama, T.; Yamaguchi, S., Phospha-fluorescein: a red-emissive fluorescein analogue with high photobleaching resistance. Chem. Commun. 2016, 52 (6), 1120-1123.
18. Fu, M.; Xiao, Y.; Qian, X.; Zhao, D.; Xu, Y., A design concept of long-wavelength fluorescent analogs of rhodamine dyes: replacement of oxygen with silicon atom. Chemical Communications 2008, (15), 1780-1782.
19. Best, Q. A.; Sattenapally, N.; Dyer, D. J.; Scott, C. N.; McCarroll, M. E., pH-Dependent Si-Fluorescein Hypochlorous Acid Fluorescent Probe: Spirocycle Ring-Opening and Excess Hypochlorous Acid-Induced Chlorination. Journal of the American Chemical Society 2013, 135 (36), 13365-13370.
20. (a) Kushida, Y.; Nagano, T.; Hanaoka, K., Silicon-substituted xanthene dyes and their applications in bioimaging. Analyst 2015, 140 (3), 685-695; (b) Butkevich, A. N.; Mitronova, G. Y.; Sidenstein, S. C.; Klocke, J. L.; Kamin, D.; Meineke, D. N. H.; D'Este, E.; Kraemer, P.-T.; Danzl, J. G.; Belov, V. N.; Hell, S. W., Fluorescent Rhodamines and Fluorogenic Carbopyronines for Super-Resolution STED Microscopy in Living Cells. Angewandte Chemie International Edition 2016, 55 (10), 3290-3294.
21. N. S. James, Y. Chen, P. Joshi, T. Y. Ohulchanskyy, M. Ethirajan, M. Henary, L. Strekowski, and R. K. Pandey, Theranostics 2013, 3, 692-702.
22. E. D. Cosco, J. R. Caram, O. T. Bruns, D. Franke, R. A. Day, E. P. Farr, M. G. Bawendi, and E. M. Sletten, Angew.Chem. Int. Ed. 2017, 56, 13126-13129.
23. M. Levitus, Methods Appl. Fluoresc. 2020 8, 1-22.
24. R. M. Uppu, Analytical Biochemistry 2006, 354, 165-168.
25 W. Huang, S. L. Buchwald, Chemistry—A European Journal 2016, 22, 14186-14189.
26 W. Liu, H. H. McGarraugh, B. D. Smith, Molecules 2018, 23, 2229.
27 C. C. Woodroofe, M. H. Lim, W. Bu, S. J. Lippard, Tetrahedron 2005, 61, 3097-3105.

What is claimed is:

1. A short-wave infrared (SWIR) dye comprising a counterion and a structure of Formula I 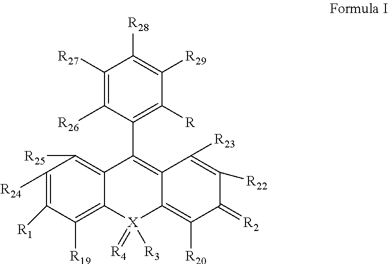
wherein X is selected from the group consisting of O, Si and P;
R is selected from the group consisting of hydrogen, —C(O)OH, a substituted or unsubstituted linear or branched C₁-C₁₈ alkyl group, a substituted or unsubstituted linear or branched C₂-C₁₈ alkenyl group, a substituted or unsubstituted C₃-C₁₀ cycloalkyl group, a substituted or unsubstituted linear or branched C₁-C₁₈ alkoxy group, an ester group represented by the formula —C(O)OA¹, wherein A¹ is a substituted or unsubstituted linear or branched C₁-C₁₈ alkyl group, a substituted or unsubstituted linear or branched C₂-C₁₈ alkenyl group or a substituted or unsubstituted C₃-C₁₀ cycloalkyl group,
an amide group represented by the formula —C(O)N(A²)₂, wherein A² is selected from the group consisting of a substituted or unsubstituted linear or branched C₁-C₁₈ alkyl group, a substituted or unsubstituted linear or branched C₂-C₁₈ alkenyl group, a substituted or unsubstituted C₃-C₁₀ cycloalkyl group, and a substituted or unsubstituted C₆-C₁₀ aryl group, and
an ether group represented by the formula —CH₂OA³ wherein A³ is selected from the group consisting of a substituted or unsubstituted linear or branched C₁-C₁₈ alkyl group, a substituted or unsubstituted linear or branched C₂-C₁₈ alkenyl group, and a substituted or
when X is O, then R₃ and R₄ are absent, and
when X is Si, then R₃ and R₄ are each singly bonded to the Si atom, and are independently selected from the group consisting of hydrogen, a substituted or unsubstituted C₁-C₁₈ linear or branched alkyl group, and a substituted or unsubstituted C₃-C₁₀ cycloalkyl group, and
when X is P, then R₃ is singly bonded to the P atom and is selected from the group consisting of hydrogen, a substituted or unsubstituted C₁-C₁₈ linear or branched alkyl group, and a substituted or unsubstituted C₃-C₁₀ cycloalkyl group, and R₄ is singly bonded to the P atom and is a substituted or unsubstituted C₁-C₁₈ linear or branched alkyl group or a substituted or unsubstituted C₃-C₁₀ cycloalkyl group, or R₄ is doubly bonded to the P atom and is an oxygen;
R₁₉, R₂₀, R₂₂, R₂₃, R₂₄, R₂₅, R₂₆, R₂₇, R₂₈, and R₂₉ are each independently selected from the group consisting of hydrogen, sulfonate, halogen, hydroxy, amino, nitro, cyano, carboxy, an alkyl group having 1 to 20 carbon atoms, an alkenyl group having 2 to 20 carbon atoms, an alkynyl group having 2 to 20 carbon atoms, an aryl group having 6 to 10 carbon atoms, a heterocyclic group having 3 to 16 carbon atoms, an alkylether group having 2 to 20 carbon atoms and 1 to 5 oxygen atoms, and an alkoxy group having 1 to 20 carbon atoms, or wherein one or more pair(s) of R₂₂ and R₂₃, R₂₄ and R₂₅, R₂₅ and R₂₆, R₂₆ and R₂₇, R₂₇ and R₂₈, R₂₈ and R₂₉, together with the carbons to which they are attached form a saturated or unsaturated 6 membered ring; and
R₁ and R₂ are both selected from one of the following Groups A, B and C:
Group A
R₁ is hydrogen and R₂ is a donor which is substituted or unsubstituted and is selected from the group consisting of a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, and a thienodihydrodibenzazepine; or
Group B
both R₁ and R₂ are the same donors, are substituted or unsubstituted, and are selected from the group consisting of a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, and a thienodihydrodibenzazepine; or
Group C
R₁ and R₂ are different donors and R₁ is a donor which is substituted or unsubstituted and is selected from the group consisting of a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, and a thienodihydrodibenzazepine, and R₂ is a donor which is substituted or unsubstituted and is selected from the group consisting of a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, a thienodihydrodibenzazepine, 1-(thiophen-2-yl)piperidine, 1-(thieno[3,2-b]thiophen-2-yl)piperidine, 1-([2,2′-bithiophen]-5-yl)piperidine, C₂-C₁₂ dialkyl amino, indolizine-3-yl, diphenylamino, and julolidinyl.

2. The SWIR dye of claim 1, wherein X is O, and R₃ and R₄ are absent;
R is —C(O)OH, or
R is an ester group, an amide group, or an ether group and A¹, A², and A³ are independently selected from the group consisting of a linear or branched C₁-C₁₈ alkyl group, a linear or branched C₂-C₁₈ alkenyl group, a C₃-C₁₀ cycloalkyl group, and a substituted or unsubstituted C₆-C₁₀ aryl group that is substituted with 1 to 3 substituents independently selected from a halogen, sulfonate, hydroxy, amino, nitro, cyano, carboxy, an alkyl group having 1 to 20 carbon atoms, an alkenyl group having 2 to 20 carbon atoms, an alkynyl group having 2 to 20 carbon atoms, an aryl group having 6 to 10 carbon atoms, a heterocyclic group having 3 to 16 carbon atoms, and an alkoxy group having 1 to 20 carbon atoms.

3. The SWIR dye of claim 1, wherein X is O, and R₃ and R₄ are absent;
R is —C(O)OH or an ester group represented by the formula: —C(O)OA¹ wherein A¹ is selected from a linear or branched C₁-C₆ alkyl group, or R is an amide group represented by the formula: —C(O)N(A²)₂, wherein A² is a C₆-C₁₀ aryl group which is optionally substituted by an amino group; and
R₁ and R₂ are both selected from one of the following Groups A and B:
Group A
R₁ is hydrogen and R₂ is a donor which is substituted with 0 to 3 substituents and is selected from the group consisting of a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, and a thienodihydrodibenzazepine; and
Group B
both R₁ and R₂ are the same donors, are substituted with 0 to 3 substituents, and are selected from the group consisting of a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, and a thienodihydrodibenzazepine;
wherein the substituents are independently selected from the group consisting of a halogen, sulfonate, hydroxy, amino, nitro, cyano, carboxy, an alkyl group having 1 to 20 carbons, an alkenyl group having 2 to 20 carbon atoms, an alkynyl group having 2 to 20 carbon atoms, an alkylether group having 2 to 20 carbon atoms and 1 to 5 oxygen atoms, an aryl group having 6 to 10 carbon atoms, a heterocyclic group having 3 to 16 carbons, and an alkoxy group having 1 to 20 carbon atoms.

4. The SWIR dye of claim 1, wherein X is O, and R₃ and R₄ are absent;
R is —C(O)OH or an ester group represented by the formula: —C(O)OA¹ wherein A¹ is selected from a linear or branched C₁-C₆ alkyl group, or R is an amide group represented by the formula: —C(O)N(A²)₂, wherein A² is a C₆-C₁₀ aryl group which is optionally substituted by an amino group; and
R₁ and R₂ are both selected from Group C:
Group C
R₁ and R₂ are different donors, R₁ is a donor which is substituted with 0 to 3 substituents and is selected from the group consisting of a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, and a thienodihydrodibenzazepine, and R₂ is a donor which is substituted with 0 to 3 substituents, and is selected from the group consisting of a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, a thienodihydrodibenzazepine, 1-(thiophen-2-yl)piperidine, 1-(thieno[3,2-b]thiophen-2-yl)piperidine, 1-([2,2′-bithiophen]-5-yl)piperidine, C₂-C₁₂ dialkyl amino, indolizine-3-yl, diphenylamino, and julolidinyl;
wherein the substituents are independently selected from the group consisting of a halogen, sulfonate, hydroxy, amino, nitro, cyano, carboxy, an alkyl group having 1 to 20 carbon atoms, an alkenyl group having 2 to 20 carbon atoms, an alkynyl group having 2 to 20 carbon atoms, an alkylether group having 2 to 20 carbon atoms and 1 to 5 oxygen atoms, an aryl group having 6 to 10 carbon atoms, a heterocyclic group having 3 to 16 carbon atoms, and an alkoxy group having 1 to 20 carbon atoms.

5. The SWIR dye of claim 1, wherein X is O, and R₃ and R₄ are absent;
R is —C(O)OH or an ester group represented by the formula: —C(O)OA¹ wherein A¹ is selected from a linear or branched C₁-C₆ alkyl group, or R is an amide group represented by the formula: —C(O)N(A²)₂, wherein A² is a C₆-C₁₀ aryl group which is optionally substituted by an amino group; and
R₁ and R₂ are both selected from Group C:
Group C
R₁ and R₂ are different donors, R₁ is a donor which is substituted with 0 to 3 substituents and is selected from the group consisting of a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, and a thienodihydrodibenzazepine and R₂ is a donor which is substituted with 0 to 3 substituents and is selected from the group consisting of a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, a thienodihydrodibenzazepine, 1-(thiophen-2-yl)piperidine, 1-(thieno[3,2-b]thiophen-2-yl)piperidine, 1-([2,2′-bithiophen]-5-yl)piperidine, diethyl amino, and julolidinyl;
wherein the substituents are independently selected from the group consisting of halogen, sulfonate, hydroxy, amino, nitro, cyano, carboxy, an alkyl group having 1 to 20 carbon atoms, an alkenyl group having 2 to 20 carbon atoms, an alkynyl group having 2 to 20 carbon atoms, an alkylether group having 2 to 20 carbon atoms and 1 to 5 oxygen atoms, an aryl group having 6 to 10 carbon atoms, a heterocyclic group having 3 to 16 carbon atoms, and an alkoxy group having 1 to 20 carbon atoms.

6. The SWIR dye of claim 1, wherein the counterion is selected from the group consisting of nitrite, sulfate, phosphate, bicarbonate, trifluoroacetate, pentafluoropropanoate, chloride, bromide, iodide, perchlorate, nitrate, benzenesulfonate, p-toluenesulfonate, methylsulfate, ethylsulfate, propylsulfate, tetrafluoroborate, tetraphenylborate, hexafluorophosphate, benzenesulfinate, acetate, trifluoroacetate, propionacetate, benzoate, oxalate, succinate, malonate, oleate, stearate, citrate, monohydrogen diphosphate, dihydrogen monophosphate, pentachlorostannate, chlorosulfonate, fluorosulfonate, trifluoromethansulfonate, hexafluoroarsenate, hexafluoroantimonate, molybdenate, tungstate, titanate, zirconate ions, and any combination thereof.

7. The SWIR dye of claim 1, wherein the counterion is selected from the group consisting of trifluoroacetate, pentafluoropropanoate, chloride, bromide, iodide, fluorosulfonate, and trifluoromethansulfonate.

8. The SWIR dye of claim 1, wherein R₁₉, R₂₀, R₂₂, R₂₃, R₂₄, R₂₅, R₂₆, R₂₇, R₂₈, and R₂₉ are each independently selected from the group consisting of hydrogen, sulfonate, halogen, hydroxy, amino, nitro, cyano, carboxy, an alkyl group having 1 to 6 carbon atoms, an alkenyl group having 2 to 6 carbon atoms, an alkylether group having 2 to 20 carbon atoms and 1 to 5 oxygen atoms, an aryl group having 6 to 10 carbon atoms, and a heterocyclic group having 6 to 10 carbon atoms, and wherein 0 or 1 pair of R₂₂ and R₂₃, R₂₄ and R₂₅, R₂₅ and R₂₆, R₂₆ and R₂₇, R₂₇ and R₂₈, R₂₈ and R₂₉, together with the carbons to which they are attached from form a saturated or unsaturated six membered ring.

9. The SWIR dye of claim 1, wherein R₁₉, R₂₀, R₂₂, R₂₃, R₂₄, R₂₅, R₂₆, R₂₇, R₂₈, and R₂₉ are each independently selected from the group consisting of hydrogen, halogen, hydroxy, an alkyl group having 1 to 6 carbon atoms, and a phenyl group.

10. The SWIR dye of claim 1, wherein R_{19.} R_{20.} R_{22.} R_{23.} R_{24.} R_{25.} R_{26.} R_{27.} R_{28.} and R₂₉ arc each hydrogen.

11. The SWIR dye of claim 1, wherein the SWIR dye has one of the following structures:

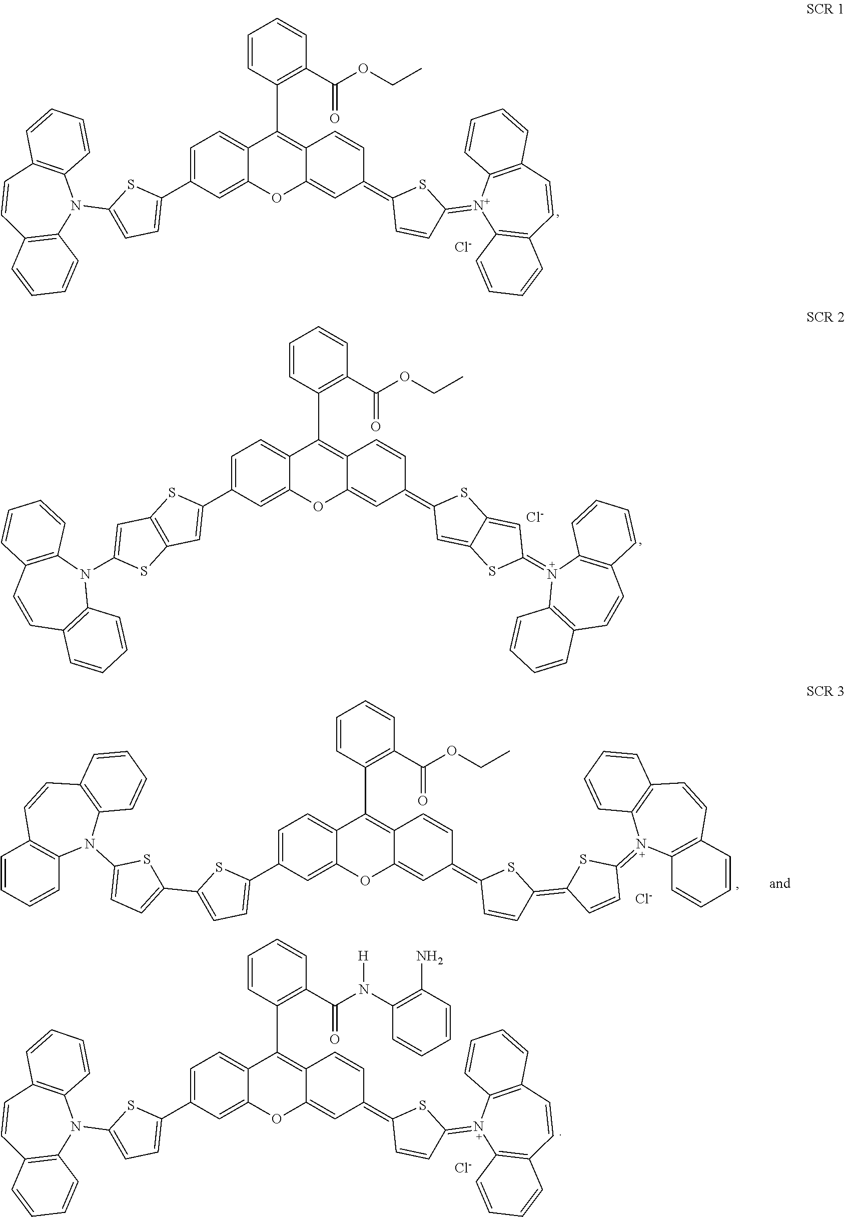

12. The SWIR dye of claim 1, wherein the SWIR dye absorbs light having a wavelength of from about 800 nm to about 1400 nm.

13. A composite comprising the SWIR dye of claim 1 in a polymer matrix.

14. The composite according to claim 13, wherein the polymer matrix is solid at room temperature.

15. A composite comprising the SWIR dye of claim 1 encapsulated in a phospholipid-polymer conjugate.

16. The composite according to claim 15, wherein the phospholipid-polymer conjugate is 1,2-distearoyl-sn-glycero-3-phosphoethanolamine-poly(ethylene glycol) (DSPE-PEG).

17. A method for making a SWIR dye, the method comprising steps of:
(a) performing a C—H arylation reaction by combining a Donor and an Acceptor of Formula II with a catalyst in a solvent to form a reaction mixture, 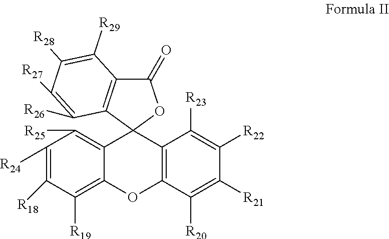
wherein R₁₈ and R₂₁ are independently selected from the group consisting of Cl, Br, I, and OSO₂R₅₂ wherein R₅₂ is a hydrogen or C₁-C₄ alkyl;
R₁₉, R₂₀, R₂₂, R₂₃, R₂₄, R₂₅, R₂₆, R₂₇, R₂₈, and R₂₉ are each independently selected from the group consisting of hydrogen and an alkyl group having 1 to 20 carbons, or wherein one or more pair(s) of R₂₂ and R₂₃, R₂₄ and R₂₅, R₂₅ and R₂₆, R₂₆ and R₂₇, R₂₇ and R₂₈, R₂₈ and R₂₉, together with the carbons to which they are attached from form a saturated or unsaturated six membered ring; and
the Donor(s) is substituted or unsubstituted and comprises at least one from Group (X) and one from Group (Y):
Group (X) dibenzazepinyl, thienyldibenzazepine, bithienyldibenzazepine, thienodibenzazepine, dihydrodibenzazepinyl, thienyldihydrodibenzazepine, bithienyldihydrodibenzazepine, and thienodihydrodibenzazepine; and
Group (Y) dibenzazepinyl, thienyldibenzazepine, bithienyldibenzazepine, thienodibenzazepine, dihydrodibenzazepinyl, thienyldihydrodibenzazepine, bithienyldihydrodibenzazepine, thienodihydrodibenzazepine, 1-(thiophen-2-yl)piperidine, 1-(thieno[3,2-b]thiophen-2-yl)piperidine, 1-([2,2′-bithiophen]-5-yl)piperidine, C₂-C₁₂ dialkyl amine, indolizine, diphenylamine, and julolidine,
to thereby replace the groups at R₁₈ and R₂₁ with said Donor(s);
(b) a ring opening reaction by transesterification with an alcohol to give the SWIR dye of Formula I 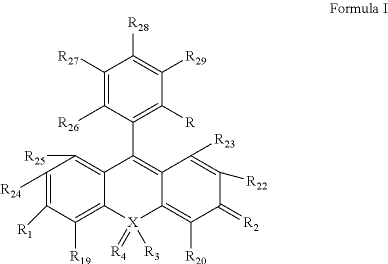
wherein X is O, and R₃ and R₄ are absent;
R is selected from —C(O)OH or an ester group represented by the formula —C(O)OA¹, wherein A¹ is a linear or branched C₁-C₁₈ alkyl group;
are each independently selected from the group consisting of hydrogen and an alkyl group having 1 to 20 carbons, or wherein one or more pair(s) of R₂₂ and R₂₃, R₂₄ and R₂₅, R₂₅ and R₂₆, R₂₆ and R₂₇, R₂₇ and R₂₈, R₂₈ and R₂₉, together with the carbons to which they are attached from form a saturated or unsaturated six membered ring; and
R₁ and R₂ are each selected from one of the following Groups B and C:
Group B
both R₁ and R₂ are the same donors, both are substituted or unsubstituted, and are selected from the group consisting of a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, and a thienodihydrodibenzazepine; and
Group C
R₁ and R₂ are different donors, R₁ is a donor which is substituted or unsubstituted and is selected from the group consisting of a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, and a thienodihydrodibenzazepine and R₂ is a donor which is substituted or unsubstituted and is selected from the group consisting of a dibenzazepinyl, a thienyldibenzazepine, a bithienyldibenzazepine, a thienodibenzazepine, a dihydrodibenzazepinyl, a thienyldihydrodibenzazepine, a bithienyldihydrodibenzazepine, a thienodihydrodibenzazepine, 1-(thiophen-2-yl)piperidine, 1-(thieno[3,2-b]thiophen-2-yl)piperidine, 1-([2,2′-bithiophen]-5-yl)piperidine, C₂-C₁₂ dialkyl amino, indolizine-3-yl, diphenylamino, and julolidinyl.

18. The method for making the SWIR dye of claim 17, wherein the compound of Formula II is:

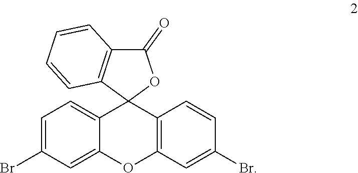 [SMILES: O=C1OC2(c3ccc(Br)cc3Oc3cc(Br)ccc32)c2ccccc21]

19. A composition comprising the SWIR dye of claim 1 and a pharmaceutically acceptable carrier or a solid polymer matrix.

20. A method for imaging a biological sample, the method comprising steps of:
(a) contacting the biological sample with an effective amount of the composition of claim 19;
(b) exposing the biological sample and the composition to SWIR radiation; and
(c) observing photoacoustic resonance or fluorescence in the biological sample.
